(19) United States
(12) Patent Application Publication
(10) Pub. No.: US 2024/0294784 A1
(43) Pub. Date: Sep. 5, 2024

(54) COATING COMPOSITION COMPRISING A SUSTAINABLE PIGMENT AND METHOD OF COATING A SUBSTRATE USING THE SAME

(71) Applicant: BASF COATINGS GMBH, Münster (DE)

(72) Inventors: Jens-Henning RUEMPEL, Münster (DE); Meng Yun ZHU, Shanghai (CN); Zhao LIU, Shanghai (CN); Simon WINZEN, Münster (DE); Stefanie Schweins, Münster (DE)

(21) Appl. No.: 18/043,997

(22) PCT Filed: Sep. 8, 2022
(86) PCT No.: PCT/EP2022/074931

§ 371 Date: Mar. 3, 2023

(30) Foreign Application Priority Data
Sep. 13, 2021 (WO) PCT/CN2021/118022
Sep. 20, 2021 (EP) 21197739.2

(51) Int. Cl. C09D 7/61; C08J 7/04; C08J 9/36; C09D 7/40; C09D 7/80; C09D 17/00; C09D 175/04

(52) U.S. Cl. CPC C09D 7/61; C08J 7/0427; C09D 7/69; C09D 7/80; C09D 17/005; C09D 175/04; C08J 9/365; C08J 2375/04

(57) ABSTRACT

Described herein is an aqueous coating composition including at least one binder, at least one sustainable pigment selected from recycled carbon black or coffee grounds or tea, at least one solvent and optionally at least one crosslinking agent and/or at least one additive. The use of the sustainable pigments in the aqueous coating results in colored coatings on substrates, such as flexible foam substrates, having a high optical quality as well as good mechanical properties. Also described herein is a process for producing the aqueous coating composition and a method for coating a substate using the aqueous coating composition. Finally, described herein is a substrate bearing a coating produced by the method.

The present invention relates to a coating composition comprising at least one binder, at least one sustainable pigment selected from recycled carbon black or coffee grounds or tea, at least one solvent and optionally at least one crosslinking agent and/or at least one additive. The use of the sustainable pigments in the composition results in colored coatings on substrates, such as flexible foam substrates, having a high optical quality as well as good mechanical properties. The present invention moreover relates to a process for producing the inventive coating composition and a method for coating a substate using the inventive coating composition. Finally, the present invention relates to a substrate bearing a coating produced by the inventive method.

### STATE OF THE ART

A wide variety of different substrates with variable layer thicknesses are nowadays coated with coating compositions in a downstream process after production of the substrate to provide visual enhancement of the substrate and/or to provide protection of the substrate from environmental influences, such as soil, stone chipping, weathering, etc.

Such aqueous or solvent-based coating compositions normally contain pigments and/or dyes in a binder matrix which, upon curing, forms the colored coating layer. A huge majority of pigments and/or dyes currently used in such coating compositions is produced from petroleum aromatic chemistry or processes requiring high temperature, thus their production contributes significantly to the global warming. Furthermore, the chemical operations necessary to purify intermediates or final products, in order to be commercialized and used, requires lots of energetic resources and also generates undesirable additional by-products.

The negative impact on the environment when using such pigments and/or dyes has stipulated the industry to use pigments and/or dyes coming from more sustainable sources, such as real dye plants or natural occurring sources. However, these approaches have some drawbacks since the demand of pigments and/or dyes cannot be satisfied without damaging the environment during cultivation of the dye plants and naturally occurring pigment sources are limited in terms of quantity.

A more promising approach seems to be the use of waste, such as vegetal waste or industry waste, to produce pigments and/or dyes. This allows to improve the sustainability of such coating compositions because it significantly reduces the CO₂ generation associated with the petroleum aromatic chemistry used to produce pigments and/or dyes and does not require large cultivation areas or the exploitation of natural resources.

However, the performance of pigments and/or dyes produced from vegetal or industry waste must at least be comparable to commonly used pigments and/or dyes to ensure that the optical quality of the resulting coating layer achieves the high demands of industry and customers in this respect. Moreover, their use should not negatively influence the mechanical properties, such as the adhesion, weathering stability, flexibility, etc., of the resulting coating layer to satisfy existing industry standards. Finally, these pigments and/or dyes must allow to adapt the optical appearance of the resulting coating layer to ensure that different color nuances desired by the customers can be produced. It must therefore be possible to adapt the optical and/or esthetic properties of the coated substrate when using pigments produced from waste.

Thus, there is a need for coating compositions containing sustainable pigments, i.e. pigments prepared from vegetal or industry waste, which can be used to coat a wide variety of substrates, for example synthetic and natural substrates used in the automotive interior sector, the footwear industry and the furniture industry, and which result in colored coating layers having a high quality optical appearance, in particular an optical appearance which is comparable to the optical appearance achieved with non-sustainable pigments (i.e. pigments not being prepared from waste), as well as excellent mechanical properties, such as adhesion, flexibility, weathering stability and abrasion resistance. The optical properties of the coating layers resulting from these coating compositions should be adaptable to generate colored substrates having the desired optical appearance.

### OBJECT

Accordingly, an object of the present invention is to provide a coating composition comprising sustainable pigments, i.e. pigments produced from vegetal and/or industry waste, which results in coating layers having a high optical quality as well as good mechanical properties. In particular, the coating compositions should be suitable for a wide variety of synthetic and natural substrates and should result in coating layers having a high adhesion to the substrate while being sufficiently flexible to prevent breaking of the coating layer upon bending of the substrate. Moreover, the optical appearance of the coating layer resulting from said compositions should be adaptable to the specific needs of the respective customer. Furthermore, an object of the present invention is to provide a process for coating a substrate with said coating compositions to allow the production of coated substrates having a high optical appearance and good mechanical properties.

### TECHNICAL SOLUTION

The objects described above are achieved by the subject matter claimed in the claims and also by the preferred embodiments of that subject matter that are described in the description hereinafter.

A first subject of the present invention is therefore a coating composition comprising:
a) at least one binder,
b) at least one pigment selected from recycled carbon black or coffee grounds or tea,
c) at least one solvent,
d) optionally at least one crosslinking agent, and
e) optionally at least one additive.

The above-specified coating composition is hereinafter also referred to as coating composition of the invention and accordingly is a subject of the present invention. Preferred embodiments of the coating composition of the invention are apparent from the description hereinafter and also from the dependent claims.

In light of the prior art it was surprising and unforeseeable for the skilled worker that the objects on which the invention is based could be achieved by using recycled carbon black or coffee grounds or tea as sustainable pigment in a coating composition. The use of recycled carbon black pigment allows to tune the appearance of the resulting coating layer because a lighter black colored coating layer is obtained if the recycled carbon black pigment is used in powder form as compared to the use of a pigment paste comprising recycled carbon black pigment. Moreover, the obtained color can be tuned by adjusting the amount of recycled carbon black pigment. The inventive coating compositions result in coating layers having a good appearance, in particular a high hiding power and a uniform appearance not comprising any visual defects, and good mechanical properties, irrespective of the substrate and thus allows to provide aesthetically appealing coated substrates having the required mechanical properties. Moreover, the sustainable pigments can be incorporated into aqueous as well as solvent-borne coating compositions, thus allowing to tune the coating composition to the respective costumer needs and coating process (i.e. post-mold coating, in-mold coating or transfer coating processes).

A further subject of the present invention is a method for producing a coating composition, said method comprising
(i) providing at least one pigment selected from recycled carbon black or coffee grounds or tea or providing a pigment paste comprising recycled carbon black pigment and
(ii) adding the pigment or pigment paste provided in step (i) to at least one binder, at least one solvent and optionally at least one crosslinking agent and/or at least one additive.

When using recycled carbon black pigment to prepare the coating composition, a “used” look, i.e. a lighter dark colored coating layer is obtained on the substrate while the use of a pigment paste comprising recycled carbon black results in a blacker color of the coating layer which is comparable to currently used black pigment pastes comprising virgin carbon black (i.e. carbon black not produced from waste). Moreover, the color of the coating layer can be adjusted by varying the amounts of recycled carbon black pigment. This allows to easily adapt the final appearance of the coated substrates and to tune the appearance of the coated substrate to the respective needs of the customer.

A further subject of the present invention is a method for producing a coating (B) on a substrate (S). According to a first alternative of the inventive method, producing the coating (B) on the substrate (S) comprises a step of producing a colored coating (BC) directly on the substrate (S) by applying an inventive coating composition (C1) or a coating composition (C1) produced by the inventive method directly to the substrate (S) and optionally drying the applied coating composition (C1) to form a coating film and curing the applied coating composition (C1) or the formed coating film. If the substrate (S) has been produced using a mold, this process is also referred to as post-mold coating process.

According to a second alternative of the inventive method, the coating (B) is produced on the substrate (S) via an in-mold coating process comprising a step of applying the inventive coating composition (C1) or a coating composition (C1) produced by the inventive method to at least one inner surface of a mold and optionally drying the applied coating composition (C1), a step of applying a composition forming the substrate (S) into the mold and a step of forming the substrate (S) while simultaneously curing the coating composition (C1).

According to a third alternative of the inventive method, the coating (B) is produced on the substrate (S) via a transfer coating process comprising a step of applying the inventive coating composition (C1) or a coating composition (C1) produced by the inventive method to a structured matrix or mold and curing the applied coating composition (C1), a step of forming a bonding layer on the cured coating composition (C1) and a step of applying a substrate to the bonding layer.

The inventive methods are applicable to a wide variety of synthetic and natural substrates which are, for example, used in the automotive interior industry, the footwear industry and the furniture industry.

A further subject of the present invention is a coating produced by the inventive method as well as a substrate bearing an inventive coating.

### DETAILED DESCRIPTION

### Definitions

First of all, a number of terms used in the context of the present invention will be explained.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “aqueous coating composition” refers to a coating composition which comprises a water fraction of at least 20 wt. %, preferably at least 25 wt. %, very preferably at least 50 wt. %, based in each case on the total weight of the coating composition. The water fraction is preferably 40 to 60 wt. %, more particularly 45 to 70 wt. %, very preferably 50 to 80 wt. %, based in each case on the total weight of the coating composition. In contrast, the term “solvent-based coating composition” refers to a coating composition with comprises a fraction of organic solvents of at least 20 wt. %, preferably at least 25 wt. %, very preferably at least 45 wt. %, based in each case on the total weight of the coating composition. The organic solvent fraction is preferably 40 to 70 wt. %, more particularly 45 to 65 wt. %, very preferably 50 to 60 wt. %, based in each case on the total weight of the coating composition.

As used herein, the term “recycled carbon black pigment” refers to carbon black pigment sourced from a recycled material. Such recycled material can include reclaimed or recycled vulcanized rubber, whereby the vulcanized rubber is typically reclaimed from manufactured articles such as a pneumatic tire, an industrial conveyor belt, a power transmission belt, and a rubber hose. The recycled carbon black may be obtained by a pyrolysis process or other methods known for obtaining recycled carbon black. In an aspect, a recycled carbon black can be formed from incomplete combustion of recycled rubber feedstock or rubber articles. The recycled carbon black pigment is preferably utilized in the coating composition in powder form. In contrast, the term “virgin carbon black or virgin carbon black pigment” as used herein refers to carbon blacks or carbon black pigments traditionally formed from incomplete combustion of hydrocarbon feedstock.

The term “coffee grounds” as used herein refers to used coffee grounds obtained after brewing coffee using ground coffee beans or ground coffee beans, in particular ground coffee beans intended for disposal as waste. With particular preference, the term “coffee grounds” refers to coffee grounds obtained after brewing coffee using ground coffee beans.

The term “tea” as used herein refers to dried tea leaves, in particular dried tea leaves intended for disposal as waste or tea residues obtained after brewing tea leaves.

The term “pigment” as used herein refers to powder- or platelet-shaped pigments which, in contrast to dyes, are insoluble in the surrounding medium and are used in coating compositions to achieve a certain visual impression (DIN 55943:1993-11, DIN EN 971-1:1996-09). Such pigments can be divided a) according to their origin into naturally occurring or synthetic pigments; b) according to their chemistry into inorganic and organic pigments; c) according to coloristic effect into white, colored, black and luster pigments. The term pigment does, however, not include functional pigments, such as anti-corrosion pigments and magnetic pigments. In contrast, the term “filler” as used herein refers to a substance in granular or powder form that is insoluble in the surrounding medium and that is used in coating materials to achieve or influence certain physical properties (see DIN 55943: 1993-11, DIN EN 971-1: 1996-09).

The term “pigment paste” as used herein refers to pigment preparations or pigment mixtures in carrier materials (media), in which the pigments are present in a higher concentration than is appropriate for later use. Suitable carrier materials include aqueous or solvent-based binders or binder mixtures, to which wetting agents and sometimes other additives are added. The carrier material should be identical to the medium in which the pigment paste is incorporated or should at least be compatible with it.

As used herein, the term “applying the coating composition directly to the substrate” refers to the application of the coating composition directly on the substrate, i.e. the coating layer produced from the coating composition is in direct contact with the substrate such that no other layer is present between the produced coating layer and the substrate.

As used herein, the term “drying” of the applied coating composition (C1) refers to the evaporation of solvents from the applied coating composition (C1). Drying can be performed at ambient temperature or by use of elevated temperatures. However, the drying does not result in a coating film being ready for use, i.e. a cured coating film as described below, because the coating film is still soft or tacky after drying. Accordingly, “curing” of the applied coating composition (C1) or the coating film resulting from drying the applied coating composition (C1) refers to the conversion of such a composition or film into the ready-to-use state, i.e. into a state in which the substrate provided with the respective coating layer can be transported, stored and used as intended. More particularly, a cured coating layer is no longer soft or tacky, but has been conditioned as a solid coating layer which does not undergo any further significant change in its properties, such as hardness or adhesion to the substrate, even under further exposure to curing conditions. Curing can be performed at higher temperatures and/or for longer times than used for drying of the coating composition (C1).

“Binder” in the context of the present invention and in accordance with DIN EN ISO 4618:2007-03 is the nonvolatile component of a coating composition, without pigments and fillers. Hereinafter, however, the expression is used principally in relation to particular physically and/or chemically curable polymers, examples being polyurethanes, polyesters, polyethers, polyureas, polyacrylates, polysiloxanes and/or copolymers of the stated polymers. The nonvolatile fraction may be determined according to DIN EN ISO 3251: 2018-07 at 130° C. for 60 min using a starting weight of 1.0 g.

The term “poly(meth)acrylate” refers both to polyacrylates and to polymethacrylates. Poly(meth)acrylates may therefore be composed of acrylates and/or methacrylates and may comprise further ethylenically unsaturated monomers, such as styrene or acrylic acid, for example.

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question.

### Inventive Coating Composition

The inventive coating composition comprises as mandatory ingredients at least one binder, at least one pigment selected from recycled carbon black or coffee grounds and at least one solvent. The coating composition may further comprise at least one additive as described later on to facilitate leveling of the coating composition on the substrate, dispersion of the pigment in the coating composition and to prevent mildew of the coating composition. Moreover, the coating composition may comprise at least one crosslinking agent to facilitate crosslinking of the binder.

### Binder

The first mandatory ingredient of the inventive coating composition is at least one binder. With particular preference, the at least one binder is cured “physically” or “chemically”. The term “physically curing” refers to the formation of a cured coating film through release of solvent from the aqueous coating composition, the curing being achieved through interlooping of polymer chains. The use of such binders does therefore render the presence of crosslinking agents superfluous. In contrast, the term “chemical curing” refers to the formation of a cured coating film through chemical crosslinking reactions involving functional groups capable of reacting with each other. This may be accomplished by using a binder having functional groups, such as hydroxyl groups, and a crosslinking agent having complementary functional groups capable of reacting with the functional groups of the binder, such as isocyanate groups. It is, however, also possible to use binders comprising functional groups as well as complementary functional groups, such that the use of a separate crosslinking agent is not necessary to facilitate crosslinking. The complementary functional groups of the crosslinking agent or the binder may be capped such that storage stable one component coating compositions can be obtained. Upon endcapping, the complementary functional groups of the crosslinking agent or binder are liberated to facilitate the crosslinking.

Suitable binders include (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof. With particular preference, the at least one binder is selected from polyurethanes, dispersions containing a polyurethane resin fraction containing polyurethane resin(s), poly(meth)acrylates, polyester polyols and mixtures thereof. Use of these binders results in flexible coating layers which are especially suitable for flexible substrates, such as foam substrates used in the footwear industry.

Polyurethanes (PUs) are common general knowledge, commercially available and consist in general of a soft phase of comparatively high molecular weight polyhydroxy compounds, for example of polycarbonate, polyester or polyether segments, and a urethane hard phase formed from low molecular weight chain extenders and di-or polyisocyanates. Processes for preparing polyurethanes (PUs) are common general knowledge. In general, polyurethanes (PUs) are prepared by reaction of
(a) isocyanates, preferably diisocyanates, with
(b) isocyanate-reactive compounds, typically having a molecular weight (Mw) in the range from 500 to 10 000 g/mol, preferably in the range from 500 to 5000 g/mol and more preferably in the range from 800 to 3000 g/mol, and
(c) chain extenders having a molecular weight in the range from 50 to 499 g/mol if appropriate in the presence of
(d) catalysts
(e) and/or customary additive materials.

In what follows, the starting components and processes for preparing the preferred polyurethanes (PUs) will be described by way of example. The components (a), (b), (c) and also if appropriate (d) and/or (e) customarily used in the preparation of polyurethanes (PUs) will now be described by way of example:

As isocyanates (a) there may be used commonly known aliphatic, cycloaliphatic, araliphatic and/or aromatic isocyanates, examples being tri-, tetra-, penta-, hexa-, hepta-and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-and/or 1,3-bis(isocyanatomethyl)cyclohexane (HXDI), 1,4-cyclohexane diisocyanate, 1-methyl-2,4-and/or-2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4-and/or 2,6-tolylene diisocyanate (TDI), diphenylmethane diisocyanate, 3,3′-dimethylbiphenyl diisocyanate, 1,2-diphenylethane diisocyanate and/or phenylene diisocyanate. Preference is given to using 4,4′-MDI. Preference is also given to aliphatic diisocyanates, in particular hexamethylene diisocyanate (HDI), and particular preference is given to aromatic diisocyanates such as 2,2′-, 2,4′- and/or 4,4′-diphenylmethane diisocyanate (MDI) and mixtures of the aforementioned isomers.

As isocyanate-reactive compounds (b) there may be used the commonly known isocyanate-reactive compounds, examples being polyesterols, polyetherols and/or polycarbonate diols, which are customarily also subsumed under the term “polyols”, having molecular weights (Mw) in the range of 500 and 8000 g/mol, preferably in the range from 600 to 6000 g/mol, in particular in the range from 800 to 3000 g/mol, and preferably an average functionality of 1.8 to 2.3, preferably 1.9 to 2.2, in particular 2, with regard to isocyanates. Preference is given to using polyether polyols, for example those based on commonly known starter substances and customary alkylene oxides, for example ethylene oxide, 1,2-propylene oxide and/or 1,2-butylene oxide, preferably polyetherols based on polyoxytetramethylene (poly-THF), 1,2-propylene oxide and ethylene oxide. Polyetherols have the advantage of having a higher hydrolysis stability than polyesterols, and are preferably used as component (b), in particular for preparing soft polyurethanes polyurethane (PU1).

As polycarbonate diols there may be mentioned in particular aliphatic polycarbonate diols, for example 1,4-butanediol polycarbonate and 1,6-hexanediol polycarbonate.

As polyester diols there are to be mentioned those obtainable by polycondensation of at least one primary diol, preferably at least one primary aliphatic diol, for example ethylene glycol, 1,4-butanediol, 1,6-hexanediol, neopentyl glycol or more preferably 1,4-dihydroxymethylcyclohexane (as isomer mixture) or mixtures of at least two of the aforementioned diols, and at least one, preferably at least two dicarboxylic acids or their anhydrides. Preferred dicarboxylic acids are aliphatic dicarboxylic acids such as adipic acid, glutaric acid, succinic acid and aromatic dicarboxylic acids such as for example phthalic acid and particularly isophthalic acid.

Polyetherols are preferably prepared by addition of alkylene oxides, in particular ethylene oxide, propylene oxide and mixtures thereof, onto diols such as for example ethylene glycol, 1,2-propylene glycol, 1,2-butylene glycol, 1,4-butanediol, 1,3-propanediol, or onto triols such as for example glycerol, in the presence of high-activity catalysts. Such high-activity catalysts are for example cesium hydroxide and dimetal cyanide catalysts, also known as DMC catalysts. Zinc hexacyanocobaltate is a frequently employed DMC catalyst. The DMC catalyst can be left in the polyetherol after the reaction, but preferably it is removed, for example by sedimentation or filtration.

Mixtures of various polyols can be used instead of just one polyol.

To improve dispersibility, isocyanate-reactive compounds (b) may also include a proportion of one or more diols or diamines having a carboxylic acid group or sulfonic acid group (b′), in particular alkali metal or ammonium salts of 1,1-dimethylolbutanoic acid, 1,1-dimethylolpropionic acid or

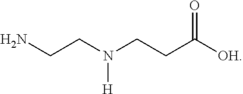

Useful chain extenders (c) include commonly known aliphatic, araliphatic, aromatic and/or cycloaliphatic compounds having a molecular weight in the range from 50 to 499 g/mol and at least two functional groups, preferably compounds having exactly two functional groups per molecule, examples being diamines and/or alkanediols having 2 to 10 carbon atoms in the alkylene radical, in particular 1,3-propanediol, 1,4-butanediol, 1,6-hexanediol and/or di-, tri-, tetra-, penta-, hexa-, hepta-, octa-, nona-and/or decaalkylene glycols having 3 to 8 carbon atoms per molecule, preferably corresponding oligo-and/or polypropylene glycols, and mixtures of chain extenders (c) can also be used.

It is particularly preferable for components (a) to (c) to comprise difunctional compounds, i.e., diisocyanates (a), difunctional polyols, preferably polyetherols (b) and difunctional chain extenders, preferably diols.

Useful catalysts (d) to speed in particular the reaction between the NCO groups of the diisocyanates (a) and the hydroxyl groups of the building block components (b) and (c) are customary tertiary amines, for example triethylamine, dimethylcyclohexylamine, N-methylmorpholine, N,N′-dimethylpiperazine, 2-(dimethylaminoethoxy)ethanol, diazabicyclo(2,2,2)octane (DABCO) and similar tertiary amines, and also in particular organic metal compounds such as titanic esters, iron compounds such as for example iron(III) acetylacetonate, tin compounds, for example tin diacetate, tin dioctoate, tin dilaurate or the tin dialkyl salts of aliphatic carboxylic acids such as dibutyltin diacetate, dibutyltin dilaurate or the like. The catalysts are typically used in amounts of 0.0001 to 0.1 part by weight per 100 parts by weight of component (b).

As well as catalyst (d), auxiliaries and/or additives (e) can also be added to the components (a) to (c). There may be mentioned for example blowing agents, antiblocking agents, surface-active substances, fillers, for example fillers based on nanoparticles, in particular fillers based on CaCO3, nucleators, glidants, dyes and pigments, antioxidants, for example against hydrolysis, light, heat or discoloration, inorganic and/or organic fillers, reinforcing agents and plasticizers, metal deactivators. In a preferred embodiment, component (e) also includes hydrolysis stabilizers such as for example polymeric and low molecular weight carbodiimides. The soft polyurethane preferably comprises triazole and/or triazole derivative and antioxidants in an amount of 0.1% to 5 wt. % based on the total weight of the soft polyurethane in question. Useful antioxidants are generally substances that inhibit or prevent unwanted oxidative processes in the plastics material to be protected. In general, antioxidants are commercially available. Examples of antioxidants are sterically hindered phenols, aromatic amines, thiosynergists, organophosphorus compounds of trivalent phosphorus and hindered amine light stabilizers. Phenolic antioxidants are preferred for use in the antioxidant mixture. In a preferred embodiment, the antioxidants, in particular the phenolic antioxidants, have a molar mass of greater than 350 g/mol, more preferably greater than 700 g/mol and a maximum molar mass (Mw) of not more than 10 000 g/mol, preferably up to not more than 3000 g/mol. They further preferably have a melting point of not more than 180° C. It is further preferable to use antioxidants that are amorphous or liquid. Mixtures of two or more antioxidants can likewise be used as component (e).

As well as the specified components (a), (b) and (c) and if appropriate (d) and (e), chain regulators (chain-terminating agents), customarily having a molecular weight of 31 to 3000 g/mol, can also be used. Such chain regulators are compounds which have only one isocyanate-reactive functional group, examples being monofunctional alcohols, monofunctional amines and/or monofunctional polyols. Such chain regulators make it possible to adjust flow behavior, in particular in the case of soft polyurethanes, to specific values. Chain regulators can generally be used in an amount of 0 to 5 parts and preferably 0.1 to 1 part by weight, based on 100 parts by weight of component (b), and by definition come within component (c).

As well as the specified components (a), (b) and (c) and if appropriate (d) and (e), it is also possible to use crosslinkers having two or more isocyanate-reactive groups toward the end of the polyurethane-forming reaction, for example hydrazine hydrate.

To adjust the hardness of polyurethane (PU), the components (b) and (c) can be chosen within relatively wide molar ratios. Useful are molar ratios of component (b) to total chain extenders (c) in the range from 10:1 to 1:10, and in particular in the range from 1:1 to 1:4, the hardness of the soft polyurethanes increasing with increasing (c) content. The reaction to produce polyurethane (PU) can be carried out at an index in the range from 0.8 to 1.4:1, preferably at an index in the range from 0.9 to 1.2:1 and more preferably at an index in the range from 1.05 to 1.2:1. The index is defined by the ratio of all the isocyanate groups of component (a) used in the reaction to the isocyanate-reactive groups, i.e., the active hydrogens, of components (b) and if appropriate (c) and if appropriate monofunctional isocyanate-reactive components as chain-terminating agents such as monoalcohols for example.

Polyurethane (PU) can be prepared by conventional processes in a continuous manner, for example by the one-shot or the prepolymer process, or batchwise by the conventional prepolymer operation. In these processes, the reactant components (a), (b), (c) and if appropriate (d) and/or (e) can be mixed in succession or simultaneously, and the reaction ensues immediately.

In one embodiment, two different polyurethanes (i.e. polyurethane (PU1) and polyurethane (PU2)) are used as binder, wherein polyurethane (PU1) is a soft polyurethane having a shore hardness of less than 60, and polyurethane (PU2) is a hard polyurethane having a shore hardness of above 60 to 100. The shore hardness can be determined according to DIN 53505:2000-08 after 3 s.

The soft polyurethane (PU1) can be prepared as previously described in relation to polyurethane (PU). Hard polyurethane (PU2) can in principle be prepared similarly to soft polyurethane (PU1), but other isocyanate-reactive compounds (b), other mixtures of isocyanate-reactive compounds (b) or other ratios of polyisocyanates, are used. Examples of such compounds (b) are in particular 1,4-butanediol, 1,6-hexanediol and neopentyl glycol, either mixed with each other or mixed with polyethylene glycol. In one example, (PU1) and (PU2) are each prepared using a mixtures of diisocyanates, for example mixtures of HDI and IPDI, however larger proportions of IPDI being chosen for the preparation of hard polyurethane (PU2) than for the preparation of soft polyurethane (PU1).

A suitable dispersion (denoted as dispersion (1) hereinafter) containing a polyurethane resin fraction containing at least one polyurethane resin includes an aqueous dispersion containing a polyurethane resin fraction having a gel fraction of the polyurethan resin fraction of at least 50 wt. %, a glass transition at a temperature of less than −20° C. and a melting transition at a temperature of less than 100° C.

Preferably, the gel fraction of the polyurethan resin fraction is at least 55 wt. % and in particular up to 100 wt. %, such as for example 98 wt. % or 99 wt. % (for measurement method, see Examples section), i.e. the polymer particles constituting the polyurethane resin fraction are at least partly intramolecularly crosslinked. The latter means that the polymer structures present within a particle equate at least partly to a typical macroscopic network with a three-dimensional network structure. While the particles can in part form crosslinking bridges between one another (something which in fact can hardly be ruled out simply from the preparation process), the system is nevertheless in any case a dispersion with discrete particles present in it that have a measurable particle size.

Preferably, the polyurethane resin fraction has its glass transition at a temperature of −100° C. to less than −20° C., very preferably of −90 to −40° C. and its melting transition at a temperature of −20° C. to less than 90° C., vey preferably −15° C. to less than 80° C. (for measurement method, see Examples section) and thus has a semicrystalline character (i.e. has amorphous domains having a glass transition temperature and crystalline domains showing a melting transition). Accordingly, the polyurethane resin fraction may comprise polyurethane resins which are semicrystalline, and/or it comprises both highly crystalline and amorphous polyurethane resins.

The dispersion medium is preferably water, i.e. the dispersion (1) is an aqueous dispersion. The particle size of the polyurethane resin particles is preferably from 1 to 100 micrometers. The particle size refers to the particle size distribution (distribution curve, volume density) present in the dispersion and does not refer to the average particle size. The distribution curves (volume density) can be determined by laser diffraction, allowing optimum capture of size distributions within the corresponding range. Measurement took place for the purposes of the present invention with a Mastersizer 3000 particle size measuring instrument (from Malvern Instruments). To set the concentration range suitable for the measurement, the sample was diluted with particle-free, deionized water as dispersing medium (refractive index: 1.33), the obscuration was set at between 3% and 15%, depending on each sample, and measurement took place in the Hydro 2000G dispersing unit (from Malvern Instruments). Measurement took place at a stirring speed of 3000 1/min, with equilibration at this speed for 5 minutes prior to the measurement. The volume-weighted size distribution was calculated using the Malvern Instruments software (version 5.60) by means of Fraunhofer approximation.

With preference, the dispersion (1), based on the total weight of the polyurethane resin fraction, comprises at least 10 wt. %, preferably at least 20 wt. %, more preferably at least 30 wt. %, and very preferably at least 50 wt. % of polyurethane resin particles having a particle size of more than 1 micrometer, preferably 1 to 100 micrometers. The polyurethane resin fraction, which consists of at least one polyurethane resin which is present in the form of disperse particles, therefore includes at least 10 wt. % (or at least 20 wt. %, 30 wt. %, 50 wt. %) of particles having such sizes.

The polyurethane resin fraction of the dispersion (1) is preferably thermochemically curable only in minor efficiency with components containing isocyanate groups, such as a polyisocyanates, for example. This means that by combining the corresponding polyurethane resins of the dispersion with a component containing isocyanate groups it is not possible to form a typical thermochemically cured coating. Accordingly, the at least one polyurethane resin in the polyurethane resin fraction preferably possesses only a minor amount of functional groups which are able to enter into crosslinking reactions with isocyanate groups under crosslinking conditions as described earlier on above.

In the preparation of the polyurethane resins which make up the polyurethane resin fraction, the amounts of the starting products for the preparation are preferably selected such that the ratio of the total molar amount of isocyanate groups to the total molar amount of functional groups which are able to enter into crosslinking reactions with isocyanate groups, more particularly of hydroxyl groups and amino groups, is greater than 0.9. More preferably the stated ratio is greater than 0.95, especially at least 1.0, very preferably exactly 1.0.

The polyurethane resin fraction preferably comprises potentially ionic groups, for example potentially anionic groups, preferably carboxylic or sulfonic acid groups, especially carboxylic acid groups. Such groups are known to be advantageous in the formation of an aqueous dispersion. Accordingly, in the preparation of the polyurethane resins which make up the polyurethane resin fraction, preference is given to using monomers which as well as groups for reaction in the preparation of urethane bonds, preferably hydroxyl groups and/or amino groups, also include carboxylic or sulfonic acid groups. In this way the groups in question are introduced into the prepolymer. Examples of compounds preferred in this context include monocarboxylic acids containing two hydroxyl groups or two amino groups, such as dihydroxypropionic acid, dihydroxysuccinic acid, and dihydroxybenzoic acid, for example, and also N-(2-aminoethyl)-2-aminoethanecarboxylic acid and N-(2-aminoethyl)-2-aminoethanesulfonic acid. Especially preferred are alpha, alpha-dimethylolalkanoic acids such as 2,2-dimethylolacetic acid, 2,2-dimethylolpropionic acid, 2,2-dimethylolbutyric acid, and 2,2-dimethylolpentanoic acid, especially 2,2-dimethylolpropionic acid, and also N-(2-aminoethyl)-2-aminoethanecarboxylic acid. A controlled, at least proportional neutralization of the stated groups using neutralizing agents already identified above is of course likewise possible.

The fraction of the polyurethane resin fraction in the dispersion (1) is preferably 15 to 60 wt. %, preferably 20 to 50 wt. %, based in each case on the total amount of the dispersion, while the fraction of water in the dispersion is preferably 40 to 85 wt. %, preferably 50 to 80 wt. %, based in each case on the total amount of the dispersion. The sum of the fraction of the polyurethane resin fraction and the fraction of water in the dispersion is preferably at least 75 wt. %, preferably at least 85 wt. %.

The dispersions (1) may be prepared by methods known to the skilled person, as for example by reaction of corresponding starting components in organic solvents for the preparation of polyurethane resins, and subsequent dispersal in aqueous phase and removal of organic solvents. Corresponding dispersions (1) are also available commercially, for example, under the trade name Novomatt GG (from Stahl B.V.).

A further suitable dispersion (denoted as dispersion (2) hereinafter and being different from the dispersion (1) previously described) containing a polyurethane resin fraction containing at least one polyurethane resin, in particular exactly one polyurethane resin, is an aqueous dispersion containing a polyurethane resin fraction having a gel fraction of at least 50 wt. %, preferably at least 60 wt. %, especially preferably of at least 75 wt. %.

The average particle size (volume average) of the polyurethane resin fraction of the dispersion (2) is preferably from 20 to 500 nanometers, more preferably from 40 to 300 nanometers. This can be measured, in accordance with DIN EN ISO 11357-1, by photon correlation spectroscopy (PCS) by means of a Malvern Nano S90 instrument (from Malvern Instruments) at 25±1° C., and can be evaluated using a digital correlator, with the assistance of the Zetasizer analytical software version 6.32 (from Malvern Instruments), and the measurements can be verified using polystyrene standards having certified particle sizes between 50 to 3000 nm.

The polyurethane resin fraction of the dispersion (2) preferably has its glass transition at a temperature of less than 0° C. The glass transition is preferably in the range from −100° C. to −20° C., more preferably −80° C. to −30° C.

Even more preferably the polyurethane resin fraction of the dispersion (2) has no melting transition in the range of less than 100° C. and therefore has a purely amorphous character.

The polyurethane resin fraction of the dispersion (2) is preferably not effectively thermochemically curable with components containing isocyanate groups, such as polyisocyanates. Hence it is the case that the hydroxyl number and the amine number of the polyurethane resin fraction of the dispersion (2) are preferably less than 20.

In the preparation of the polyurethane resins of the dispersion (2) that make up the polyurethane resin fraction, the amounts of the starting products for the preparation are preferably selected such that the ratio of the total molar amount of isocyanate groups to the total molar amount of functional groups which are able to enter into crosslinking reactions with isocyanate groups, more particularly of hydroxyl groups and amino groups, is greater than 0.9. More preferably the stated ratio is greater than 0.95, more particularly at least 1.0, very preferably exactly 1.0.

The polyurethane resin fraction of the dispersion (2) preferably comprises potentially ionic groups, as for example potentially anionic groups, preferably carboxylic or sulfonic acid groups.

The parent polyurethane resins are preferably prepared as follows. In organic solution, (i) a polyurethane prepolymer containing isocyanate groups is prepared, and (ii) this prepolymer is reacted with monocarboxylic acids containing two amino groups, before, during, or after the prepolymer has been dispersed in aqueous phase. In this way, then, the potentially anionic groups are incorporated into the polymer as well. Before, during, or after the dispersing, it is also possible optionally for a reaction to be carried out with further typical diamines, for chain extension. Monocarboxylic acids containing two amino groups and used with preference are N-(2-aminoethyl)-2-amino-ethanecarboxylic acid and N-(2-aminoethyl)-2-aminoethanesulfonic acid. The dispersions (3) used in the examples were also prepared in this way.

The fraction of the polyurethane resin fraction in the dispersion (2) is preferably 25 to 55 wt. %, preferably 30 to 50 wt. %, based in each case on the total amount of the dispersion (3) while the fraction of water in the dispersion (2) is preferably 45 to 75 wt. %, preferably 50 to 70 wt. %, based in each case on the total amount of the dispersion. The sum of the fraction of the polyurethane resin fraction and of the fraction of water in the dispersion (2) is preferably at least 75 wt. %, preferably at least 85 wt. %.

Dispersions (2) of this kind as well are available commercially, for example, under the commercial designation Bayhydrol UH (from Bayer), for example.

Suitable poly(meth)acrylates include hydroxy-functional poly(meth)acrylates. These hydroxy-functional poly(meth)acrylates preferably possess a hydroxyl number of 65 to 100 mg KOH/g, more preferably of 70 to 95 mg KOH/g, more particularly of 75 to 90 mg KOH/g or of 80 to 85 mg KOH/g. The hydroxyl number in the context of the present invention may be determined according to EN ISO 4629-2:2016 and is based in each case on the solids content.

The hydroxy-functional poly(meth)acrylates preferably possess an acid number of less than 25 mg KOH/g, more preferably an acid number of 1 to 20 mg KOH/g, very preferably an acid number of 4 to 16 mg KOH/g, more particularly of 6 to 14 mg KOH/g or of 8 to 12 mg KOH/g. The acid number for the purposes of the present invention may be determined according to DIN EN ISO 2114:2002-06 (method A) and is based in each case on the solids content.

The number-average molecular weight Mₙ and the weight-average molecular weight M_{w} may be determined by means of gel permeation chromatography (GPC) using a polymethyl methacrylate standard (PMMA standard) (DIN 55672-1:2016-03). The number-average molecular weight Mₙ of the hydroxy-functional poly(meth)acrylate is preferably in a range from 4000 to 10 000 g/mol, more preferably 5000 to 9000 g/mol, very preferably 5500 to 8000 g/mol, more particularly 6000 to 7500 g/mol. The weight-average molecular weight M_{w} of the hydroxy-functional poly(meth)acrylate is preferably in a range from 8000 to 30 000 g/mol, more preferably 10 000 to 25 000 g/mol, very preferably 12 000 to 22 000 g/mol, more particularly 14 000 to 20 000 g/mol.

The polydispersity PD (=M_{w}/Mₙ) of the hydroxy-functional poly(meth)acrylate is preferably in the range from 2 to 3, more particularly from 2.2 to 2.8. The hydroxy-functional poly(meth)acrylate preferably possesses a hydroxyl functionality of 5 to 15, more preferably of 6 to 14, more particularly of 8 to 12.

The hydroxy-functional poly(meth)acrylate may be obtained by means of the polymerization reactions that are commonplace and familiar to a person of ordinary skill in the art, from ethylenically unsaturated monomers, preferably monoethylenically unsaturated monomers. Initiators which may be used include peroxides, such as di-tert-butyl peroxide, for example. It is therefore preferred for the hydroxy-functional poly(meth)acrylate to be preparable by reaction of
(a1) at least one hydroxy-functional (meth)acrylic ester, more particularly (meth)acrylic ester of the formula HC═CRx—COO—Ry—OH, in which Rx is H or CH3 and Ry is an alkylene radical having 2 to 6, preferably 2 to 4, more preferably 2 or 3 carbon atoms,
(a2) at least one carboxy-functional ethylenically unsaturated monomer, more particularly (meth)acrylic acid, and
(a3) at least one hydroxyl-free and carboxyl-free ester of (meth)acrylic acid and/or at least one hydroxyl-free and carboxyl-free vinyl monomer, more particularly styrene.

Examples of hydroxy-functional (meth)acrylic esters (a1) are preferably hydroxyethyl methacrylate, hydroxyethyl acrylate, hydroxypropyl methacrylate, and hydroxypropyl acrylate, and with particular preference hydroxyethyl methacrylate and 2-hydroxypropyl methacrylate. The amount of hydroxy-functional (meth)acrylic esters (a1) used in preparing the hydroxy-functional poly(meth)acrylate is calculated on the basis of the target range for the hydroxyl number, of 50 to 120 mg KOH/g.

The hydroxy-functional poly(meth)acrylate preferably contains small quantities of carboxyl groups. These groups are introduced into the poly(meth)acrylate during the polymerization reaction, through the use, for example, of carboxy-functional monomers (a2), more preferably through the use of acrylic acid and/or methacrylic acid. These monomers (a2), especially (meth)acrylic acid, are present preferably in a total amount of 20 to 45 wt. %, more preferably of 25 to 40 wt. %, more particularly of 30 to 35 wt. %, based in each case on the total weight of all the monomers used in preparing the hydroxy-functional poly(meth)acrylate.

Besides the hydroxy-functional (a1) and the carboxy-functional (a2) ethylenically unsaturated monomers, use is also made when preparing the hydroxy-functional poly(meth)acrylate of ethylenically unsaturated monomers (a3), more particularly monoethylenically unsaturated monomers (a3), these monomers being free both of hydroxyl and of carboxyl groups. Employed with particular preference as vinyl monomer (a3) is styrene. The vinyl monomer (a3), more particularly styrene, is present preferably in a total amount of 30 to 60 wt. %, more preferably of 35 to 55 wt. %, more particularly of 40 to 50 wt. %, based in each case on the total weight of all the monomers used in preparing the hydroxy-functional poly(meth)acrylate.

The hydroxy-functional poly(meth)acrylate may be used in an organic solvent, preferably an aprotic solvent. A typical solvent for this purpose, for example, is n-butyl acetate, which may also be used when preparing the at least one hydroxy-functional poly(meth)acrylate. If the hydroxy-functional poly(meth)acrylate is used in a solvent, then the solvent is reckoned as part of the solvent L.

Suitable polyester polyols possess a hydroxyl number of 100 to 200 mg KOH/g, more preferably of 110 to 180 mg KOH/g, very preferably of 120 to 160 mg KOH/g, based in each case on the solids content.

The acid number of the polyester polyol is preferably 0 to 9 mg KOH/g, more particularly 0.2 to 2 mg KOH/g, based in each case on the solids content. The hydroxyl number and acid number of the polyester polyol may be determined as above in conjunction with the hydroxy-functional poly(meth)acrylate.

The number-average molecular weight of the polyester polyol is preferably in the range from 800 to 3000 g/mol, more preferably 1000 to 2000 g/mol, more particularly from 1000 to 1600 g/mol. The determination here is made as in connection with the determination of the molecular weight of the hydroxy-functional poly(meth)acrylate.

The polyester polyol is preferably branched.

The polyester polyol preferably possesses a hydroxyl functionality of 2.2 to 4, more preferably of 2.5 to 3.5, very preferably of 2.7 to 3.3.

The coating compositions may comprise a single binder or a mixture of binders. In case the coating compositions comprise a mixture of binders, the binders may be selected from the same chemical type (for example at least 2 polyurethanes) or may be selected from different chemical types (for example a poly(meth)acrylate and a polyester polyol). It may be beneficial if the coating composition comprises two different binders, preferably two different polyurethanes P1 and P2 or two different polyurethane resin fractions or a hydroxy-functional poly(meth)acrylate and a polyester polyol. In this regard, it may be preferred if the coating compositions comprise a weight ratio of the soft polyurethane (PU1) to the hard polyurethane (PU2) of 1:1 to 1:20, preferably of 1:5 to 1:15, very preferably of 1:8 to 1:12. It may further be preferred if the weight ratio of the resin fraction in the aqueous dispersion (1) to the second polyurethane resin fraction in the aqueous dispersion (2) is 5:1 to 1:5, preferably 3:1 to 1:3, very preferably 2:1 to 1.5:1. It may further be preferred if the weight ratio of the hydroxy-functional poly(meth)acrylate to the polyester polyol is 2:1 to 1:2, preferably 1.5:1 to 1:1.5, very preferably 1 to 1.2 to 1:1.4.

The at least one binder is preferably present in a total amount of 5 to 50 wt. % solids, preferably of 10 to 40 wt. % solids, very preferably of 20 to 35 wt. % solids, based in each case on the total weight of the coating composition.

### Pigment

The second mandatory component of the inventive coating compositions is at least one sustainable pigment selected from recycled carbon black or coffee grounds or tea. Use of these sustainable pigments allows to produce colored coating layers more ecologically, because the used pigments are produced from waste instead of carbonous feedstock or the use of petroleum aromatic chemistry.

The recycled carbon black pigment can be prepared, as previously described, from reclaimed manufactured articles such as pneumatic tires, industrial conveyor belts, power transmission belts, rubber hoses, etc. by pyrolysis processes or other methods known for obtaining recycled carbon black. The recycled carbon black pigment is preferably used in the form of a powder, which may be grinded prior to use to achieve the desired particle size. With preference, the recycled carbon black has a D₅₀ particle size of 1 to 150 μm, more preferably of 5 to 35 μm, even more preferably of 10 to 30 μm, very preferably of 15 to 25 μm. The particle size may be determined using transmission electron microscopy according to DIN EN ISO 21363:2022-03. Use of recycled carbon black pigment having the aforementioned particle sizes allows a uniform dispersion of the pigment in the coating composition and ensures a uniform appearance of the colored coating layer as well as a high hiding power of the colored coating layer resulting from the coating composition.

The recycled carbon black pigment may be dispersed in powder form in the coating compositions or may be incorporated into the coating compositions in the form of a pigment paste as described later on in relation to the method for preparing the inventive coating compositions. If the recycled carbon black pigment is dispersed in powder form, the resulting coating layer has a “used look”, i.e. a lighter black color than achieved when using a pigment paste comprising carbon black pigment, thus allowing to tune the appearance of the coated substrate. Suitable total amounts of recycled carbon black pigment in the coating composition include 0.1 to 10 wt. %, preferably of 0.3 to 8 wt. %, more preferably of 0.5 to 6 wt. %, very preferably of 1 to 4 wt. %, based in each case on the total weight of the coating composition.

The coffee grounds pigment is preferably a dried coffee grounds pigment. The use of dried coffee grounds pigment is beneficial in terms of improved stability of the coating composition, in particular the aqueous coating composition, and/or the resulting coating layer with respect to mildew time. The dried coffee grounds pigment can be obtained by drying coffee grounds at a temperature of 40 to 180° C., preferably of 60 to 120° C., very preferably at 120° C., for a duration of 1 to 3 hours and grinding the dried coffee grounds. It has been found that higher drying temperatures are beneficial with respect to the improved mildew time previously mentioned. The dried coffee grounds pigment is preferably grinded to a D₅₀ particle size of 50 to 450 μm, preferably of 100 to 400 μm, more preferably of 120 to 350 μm, very preferably of 150 to 300 μm. The average particle size may be determined according to DIN EN ISO 1524:2020-11.

Suitable total amounts of coffee grounds, preferably the dried coffee grounds, in the coating composition include 0.1 to 25 wt. %, preferably of 1 to 20 wt. %, more preferably of 5 to 15 wt. %, very preferably of 8 to 12 wt. %, based in each case on the total weight of the coating composition.

The tea pigment is preferably selected from dried and grinded green tea, black tea or rooibos tea pigment. Drying of the tea leaves is preferably performed as previously described in relation to obtaining the dried coffee grounds pigment. The dried tea leaves are preferably grinded to a D₅₀ particle size of 50 to 450 μm, preferably of 100 to 400 μm, more preferably of 120 to 350 μm, very preferably of 150 to 300 μm. The average particle size may be determined according to DIN EN ISO 1524:2020-11.

Suitable total amounts of tea pigment, preferably the dried and grinded green tea, black tea or rooibos tea pigment, in the coating composition include 0.1 to 25 wt. %, preferably of 1 to 20 wt. %, more preferably of 5 to 15 wt. %, very preferably of 8 to 12 wt. %, based in each case on the total weight of the coating composition.

According to a particularly preferred embodiment, the coating comprises—apart from the recycled carbon black pigment or coffee grounds pigment or tea pigment—0 wt. %, based on the total weight of the coating composition, of further pigments and/or fillers and/or dyes. Thus, particularly preferred coating compositions only comprise the recycled carbon black pigment or the coffee grounds pigment or tea pigment, preferably the dried coffee grounds pigment or dried tea pigment, as sole pigments, i.e. no further pigments and/or fillers and/or dyes are present in the coating compositions to ensure that the pigmentation is based entirely on sustainable pigments.

### Solvent

The composition of the invention may be a solvent-based composition or an aqueous composition. In the case of a solvent-based composition, organic solvents are included as a principal constituent. Organic solvents constitute volatile constituents of the composition of the invention, and undergo complete or partial vaporization on drying or flashing, respectively. The principal constituent of aqueous compositions is water.

Preferably in accordance with the invention the at least one solvent is selected from organic solvents, water, and mixtures thereof, and is present in a total amount of 40 to 90 wt. %, more preferably 45 to 85 wt. %, and very preferably 50 to 80 wt. %, especially 60 to 70 wt. %, based in each case on the total weight of the composition.

Organic solvents preferred in the context of the present invention are aprotic. With particular preference they are polar aprotic organic solvents. With very particular preference the organic solvents are chemically inert toward the remaining constituents of the composition.

Preferred organic solvents in the context of the present invention are, for example, ketones such as acetone, methyl ethyl ketone, cyclohexanone, methyl isobutyl ketone, methyl isoamyl ketone or diisobutyl ketone; esters such as ethyl acetate, n-butyl acetate, ethylene glycol diacetate, butyrolactone, diethyl carbonate, propylene-carbonate, ethylene carbonate, 2-methoxypropyl acetate (MPA), and ethyl ethoxypropionate; amides such as N,N-dimethylformamide, N,N-dimethylacetamide, N-methylpyrrolidone, and N-ethylpyrrolidone; methylal, butylal, 1,3-dioxolane, glycerol formal; and, somewhat less preferably because they are nonpolar, hydrocarbons such as benzene, toluene, n-hexane, cyclohexane, and solvent naphtha. Especially preferred solvents belong to the class of the esters, among which n-butyl acetate and 1-methoxypropyl acetate are very especially preferred.

### Crosslinking Agent

The inventive coating composition may comprise at least one crosslinking agent. This may be preferred if the binder is a chemically curable binder comprising functional groups, such as hydroxy groups, which are able to react with complementary groups present in the crosslinking agent.

Suitable crosslinking agents include amino resins, unblock polyisocyanates, at least partially blocked polyisocyanates, polycarbodiimides, UV light, heat, photoinitiators, and mixtures thereof, in particular unblocked polyisocyanates and polycarbodiimides.

Suitable unblocked polyisocyanates include hexamethylene diisocyanate, octamethylene diisocyanate, decamethylene diisocyanate, dodecamethylene diisocyanate, tetradecamethylene diisocyanate, trimethylhexane diisocyanate, tetra-methylhexane diisocyanate, isophorone (IPDI), 2-diisocyanate isocyanatopropylcyclohexyl isocyanate, dicyclohexylmethane 2,4′-diisocyanate, dicyclohexylmethane 4,4′-diisocyanate, 1,4-or 1,3-bis(isocyanatomethyl)cyclohexane, 1,4-or 1,3-or 1,2-diisocyanatocyclohexane, and 2,4-or 2,6-diisocyanato-1-methyl-cyclohexane, the dimers and trimers thereof, and also mixtures of these polyisocyanates.

Preferred polyisocyanates are the known dimers and/or trimers of the aforementioned diisocyanates, in other words, in particular, the uretdiones, iminooxadiazinediones and isocyanurates, known per se, of the aforementioned diisocyanates and mixtures of these dimers and/or trimers. Such polyurethanes are commercially available, for example under the tradename Desmodur® N 3800 (iminooxadiazinediones) or N 3900 (isocyanurates). Use of polyisocyanates containing at least one iminooxadiazinedione ring or polyisocyanates containing at least one isocyanurate ring or a mixture of such polyisocyanates is particularly preferred if the binder comprises a mixture of poly(meth)acrylate and polyester polyol previously described. In this case, the hardness of the resulting cured coating layer can be tuned by the crosslinking agent because the use of polyisocyanates containing iminooxadiazinedione structures results in cured coating layers having a higher hardness than compared to cured coating layers being prepared using polyisocyanates containing isocyanurate structures.

The polyisocyanates preferably possess an NCO group functionality of greater than 2.4 to 5, preferably 2.6 to 4, more preferably 2.8 to 3.6 or an NCO content of 9% to 16%, more preferably of 10% to 14%.

The polyisocyanates may be hydrophilically modified, i.e. they contain groups which, in comparison to groups and molecular units that are present in common polyisocyanates, are more hydrophilic. Such hydrophilic groups include polyether groups and polyester groups. Preferred hydrophilically modified polyisocyanate are therefore polyether-modified and/or polyester-modified polyisocyanates. Polyether-modified polyisocyanates are especially preferred. The use of such polyether-modified and/or polyester-modified polyisocyanates is particularly preferred in combination if the binder comprises the aqueous dispersions (1) and (2) as described previously.

To introduce the hydrophilic modifications it is possible, for example, to use the alkoxypoly(oxyalkylene) alcohols which are known to the skilled person and are also available commercially. In that case there is then a proportional reaction of the isocyanate groups in the polyisocyanate with the polymeric monoalcohols, as a result of which the polyether modifications—that is, for example, the poly(oxyalkylene) groups—are attached covalently to the polyisocyanate by formation of urethane bridges, and a hydrophilically modified polyisocyanate s formed. Similar comments apply in respect of polyester-modified polyisocyanates. Preferred are aliphatic, linear polyester groups, especially preferably polylactone groups, more preferably polycaprolactone groups. Polycaprolactones and their preparation, through reaction of a monoalcohol with epsilon-caprolactone, for example, are known. They too can be introduced into a polyisocyanate by common methods, via reaction of the at least one hydroxyl group they contain with an isocyanate group.

The fraction of isocyanate groups modified with polyester and/or polyether groups may vary widely and is situated for example in the range of 1-60 mol %, preferably 2-55 mol %, especially preferably 5-50 mol %. The stated molar fraction is based on the free isocyanate groups of the polyisocyanate before the modification. The afore-described hydrophilically modified polyisocyanates are available commercially.

Polycarbodiimides used with particular preference are obtainable by reaction of polyisocyanates with polycarbodiimides and subsequent chain extension and/or termination by means of hydrophilic compounds containing hydroxyl groups and/or amine groups. Suitable dispersions are described in the laid-open specifications EP1644428 A2 and EP1981922 A2, for example.

The coating composition preferably comprises the at least one crosslinking agent in a total amount of 1 wt. % to 40 wt. % solids, preferably of 2 to 30 wt. % solids, more particularly of 6 to 12 wt. % or 15 to 25 wt. % solids, based in each case on the total weight of the coating composition.

### Additive(s)

Apart from the at least one binder and the recycled carbon black pigment or coffee grounds pigment, the inventive coating compositions may further comprise at least one additive. Such additives may be used to enhance the visual and mechanical properties of the resulting coating layer by ensuring a uniform dispersion of the pigments in the coating composition as well as a good leveling of the applied coating composition on the substrate and avoiding foaming of the composition during application.

Suitable additives include dispersing agents, leveling agents, pH adjustment agents, defoaming agents, biocides, UV absorbers, crosslinking catalysts, ethoxylated fatty alcohols, fatty acids, polyethermodified polyalkylsiloxanes, hydroxy-functional polyalkylsiloxanes and mixtures thereof.

Dispersing agents that can be used as additives in the coating composition to disperse the recycled carbon black or coffee grounds, especially the recycled carbon black, are, for example, commonly used dispersing agents used to disperse pigments in coating compositions. Examples of such dispersing agents include (i) polycarboxylate ethers, (ii) poly(meth)acrylates, (iii) polyvinyls, (iv) copolymers, in particular block copolymers comprising a polycarboxylate ether, a poly(meth)acrylate, a polyvinyl, and any mixtures thereof; or (v) mixtures of the aforementioned polymers and copolymers. With particular preference, anionic copolymers comprising a polymethacrylate and a polyvinyl are used as dispersing agent. Such dispersing agents are commercially available as “DISPERBYK-190” (by BYK-Chemie GmbH), “TEGO Dispers 755W” (by Evonik Industries), “TEGO Dispers 765W” (by Evonik Industries), “DISPERBYK-2015” (by BYK-Chemie GmbH), “Floren GW-1500” (by Kyoeisha Chemical Co., Ltd.), Dispex® Ultra PX 4290 (BASF SE) and the like can be used. DISPERBYK-190 and TEGO Dispers 755W are each a polymer having a branched (comb-type) structure, have a copolymer chain of styrene-maleic acid, have a carboxyl group as a functional group directly bonded to the copolymer chain, and have a hydrophilic polyoxyalkylene chain branched from the copolymer chain. TEGO Dispers 765W is a polymer having a branched (comb-type) structure, has a carboxyl group as a functional group directly bonded to the polymer chain, and is a high-molecular weight polymer having a pigment-affinic functional group. DISPERBYK-2015 is a polymer having a branched (comb-type) structure, is an acrylic copolymer obtained by control polymerization, and has a carboxyl group as a functional group directly bonded to the polymer chain. Floren GW-1500 is a polymer having a branched (comb-type) structure, and has a carboxyl group as a functional group directly bonded to the polymer chain. Particularly preferred dispersing agents are Dispex® Ultra PX 4290 and TEGO Dispers 755W.

Suitable total amounts of the at least one dispersing agent include 0.1 to 10 wt. %, preferably 0.5 to 6 wt. %, very preferably 1 to 3 wt. %, based in each case on the total weight of the coating composition.

Leveling agents can be used in the coating compositions to ensure a good leveling of the applied coating composition on the substrate. A good leveling on the substrate is required to achieve a uniform optical appearance of the coating on the substrate, irrespective of the form of the substrate. Examples of suitable leveling agents include nonionic surfactants, cationic surfactants, anionic surfactants or mixtures thereof. Particularly preferred leveling agents are nonionic nonionic acetylenic diol compounds, such as nonionic acetylenic diol compounds of formula (I)

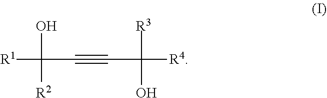

In Formula (I), each of R¹, R², R³, and R⁴ independently represents a hydrocarbon group having 1 to 20 carbon atoms which may contain one or more heteroatoms. The substituents R¹, R², R³, and R⁴ may be the same as or different from one another.

Each of R¹, R², R³, and R⁴ in Formula (I) may have a linear or branched chain structure. Among them, R¹ and R⁴ are preferably any of alkyl groups each having 2 to 10 carbon atoms, and more preferably any of those having 4 carbon atoms, i.e., n-butyl group, sec-butyl group, tert-butyl group, and isobutyl group. The substituents R² and R³ are preferably any of alkyl groups having 1 to 4 carbon atoms, and more preferably any of those having 1 or 2 carbon atoms, i.e., methyl group and ethyl group. Specific examples of the acetylenic diol compounds represented by Formula (I) include 7,10-dimethyl-8-hexadecyne-7,10-diol, 4,7-dimethyl-5-decyne-4,7-diol, 2,4,7,9-tetramethyl-5-decyne-4,7-diol, and 3,6-dimethyl-4-octyne-3,6-diol.

The acetylenic diol compound represented by Formula (I) may be a commercial product, such as Surfynol 104 Series products supplied by Air Products and Chemicals Inc., which are exemplified by Surfynol 104E, Surfynol 104H, Surfynol 104A, Surfynol 104BC, Surfynol 104DPM, Surfynol 104PA, and Surfynol 104PG-50.

Suitable total amounts of the at least one leveling agent include 0 wt. % or of 0.02 to 3 wt. %, based in each case on the total weight of the coating composition.

The at least one pH adjustment agent may be used to adjust the pH of the coating composition or the pH of the pigment paste described later on in relation to the inventive method to prepare the coating composition. Examples of suitable pH adjustment agents include inorganic and organic bases, in particular from organic nitrogen containing bases. With particular preference, N,N-dimethylethanolamine is used as pH adjustment agent.

Defoaming agents can be used in the inventive coating compositions to avoid foaming during manufacturing and application, the latter being unfavorable with respect to the optical quality of the resulting coating layer. Suitable defoaming agents are, for example, all foaming agents commonly used in coating compositions. Specific examples include polysiloxanes, hydrophobic solids, polyethermodified siloxanes, polyether siloxane copolymers and mixtures thereof. Commercially available defoaming agents which are suitable are, for example, BYK 022 (polysiloxanes and hydrophobic solids in polyglycol, BYK Chemie), BYK 342 (polyethermodified siloxane, BYK Chemie) and TEGO® Foamex 810 (polyether siloxane copolymer and fumed silica, Evonik Industry).

Suitable total amounts of the at least one defoaming agent include 0.02 to 1.5 wt. %, based in each case on the total weight of the coating composition.

The term “biocide” as used herein denotes any material, whether chemical or microbial, which can control the effects of pathogens such as bacteria, fungi, viruses, etc, whether through chemical or biological means and includes preservatives, which are understood to improve residual activity. The biocide can be used to prevent mildew in of aqueous coating compositions, especially in case coffee grounds is used as pigment. Suitable antibacterial agents include isothiazolons and isothiazolinones, such as methylisothiazolon, benzisothiazolon, chloro methylisothiazolon, methylisothiazolinone and mixtures thereof. Particularly preferred antibacterial agents are 2-methyl-2H-isothiazol-3-on, 1,2-benzisothiazol-3(2H)-on, 5-chloro-2-methyl-4-isothiazolin-3-one, 2-methyl-4-isothiazolin-3-one and mixtures thereof. Such biocides are commercially available as “Acitcide MSB 5050” (THOR Gmbh) and “Kathon™ LX-150 Biocide” (Dow).

Suitable total amounts of the at least one biocide include 0.05 to 0.3 wt. %, based in each case on the total weight of the coating composition.

UV absorbers are preferably used in the coating composition if tea pigment is present to avoid degradation of the color due to UV irradiation. Suitable UV absorbers include those commercially available under the brand name “Tinuvin”. These UV absorbers are preferably used in a total amount of 0.1 to 3 wt. %, based on the total weight of the coating composition.

Suitable crosslinking catalysts, ethoxylated fatty alcohols, fatty acids, polyethermodified polyalkylsiloxanes, hydroxy-functional polyalkylsiloxanes as well as their amounts are described, for example, in published patent application WO 2020/104213 A1.

### Exemplary Embodiments of the Coating Compositions of the Invention

In a first preferred embodiment, the coating composition of the invention, comprises or consists of 60 to 70 wt. % of an aqueous dispersion (1), 20 to 30 wt. % of an aqueous dispersion (2), 1 to 6 wt. % or 0.25 to 1.5 wt. % of recycled carbon black pigment, optionally 3 to 8 wt. % of a polyether-modified polyisocyanate, 0.5 to 3 wt. % of dispersing agent, 0.01 to 0.1 wt. % of defoamer and water, the weight percentages being based on the total weight of the coating composition.

In a second preferred embodiment, the coating composition of the invention, comprises or consists of 5 to 10 wt. % of a hydroxy-functional poly(meth)acrylate, 10 to 20 wt. % of a polyester, 1 to 6 wt. % or 0.25 to 1.5 wt. % of recycled carbon black pigment, optionally 20 to 30 wt. % of a polyisocyanate comprising at least one isocyanurate ring, 0.5 to 3 wt. % of dispersing agent, 0.01 to 0.1 wt. % of defoamer, 2 to 5 wt. % of a mixture of ethoxylated fatty alcohols and fatty acids, 0.3 to 1 wt. % of a hydroxy-functional polyalkylsiloxane, 0.3 to 1 wt. % of leveling agent and organic solvent, the weight percentages being based on the total weight of the coating composition.

In a third preferred embodiment, the coating composition of the invention, comprises or consists of 20 to 30 wt. % of a mixture of soft and hard polyurethanes in a weight ratio of 1:8 to 1:10, 1 to 6 wt. % or 0.25 to 1.5 wt. % of recycled carbon black pigment, optionally 1 to 4 wt. % of a polyisocyanate comprising at least one isocyanurate ring, 0.5 to 3 wt. % of dispersing agent, 0.01 to 0.1 wt. % of defoamer and water, the weight percentages being based on the total weight of the coating composition.

In a fourth preferred embodiment, the coating composition of the invention, comprises or consists of 60 to 70 wt. % of an aqueous dispersion (1), 20 to 30 wt. % of an aqueous dispersion (2), 0.25 to 2 wt. % of recycled carbon black pigment, optionally 3 to 8 wt. % of a polyether-modified polyisocyanate, 0.5 to 3 wt. % of leveling agent and water, the weight percentages being based on the total weight of the coating composition.

In a fifth preferred embodiment, the coating composition of the invention, comprises or consists of 5 to 10 wt. % of a hydroxy-functional poly(meth)acrylate, 10 to 20 wt. % of a polyester polyol, 0.25 to 2 wt. % of recycled carbon black pigment, 0.5 to 3 wt. % of leveling agent, optionally 20 to 30 wt. % of a polyisocyanate comprising at least one isocyanurate ring, 2 to 5 wt. % of a mixture of ethoxylated fatty alcohols and fatty acids, 0.3 to 1 wt. % of a hydroxy-functional polyalkylsiloxane, and organic solvent, the weight percentages being based on the total weight of the coating composition.

In a sixth preferred embodiment, the coating composition of the invention, comprises or consists of 20 to 30 wt. % of a mixture of soft and hard polyurethanes in a weight ratio of 1:8 to 1:10, 0.25 to 2 wt. % of recycled carbon black pigment, optionally 1 to 4 wt. % of a polyisocyanate comprising at least one isocyanurate ring, 0.5 to 3 wt. % of leveling agent and water, the weight percentages being based on the total weight of the coating composition.

In a seventh preferred embodiment, the coating composition of the invention, comprises or consists of 60 to 70 wt. % of an aqueous dispersion (1), 20 to 30 wt. % of an aqueous dispersion (2), 5 to 15 wt. % of coffee grounds or tea pigments, optionally 3 to 8 wt. % of a polyether-modified polyisocyanate, 0.05 to 0.3 wt. % of biocide and water, the weight percentages being based on the total weight of the coating composition.

In an eighth preferred embodiment, the coating composition of the invention, comprises or consists of 5 to 10 wt. % of a hydroxy-functional poly(meth)acrylate, 10 to 20 wt. % of a polyester polyol, 5 to 15 wt. % of coffee grounds or tea pigment, 0.05 to 0.2 wt. % of biocide, optionally 20 to 30 wt. % of a polyisocyanate comprising at least one isocyanurate ring, 2 to 5 wt. % of a mixture of ethoxylated fatty alcohols and fatty acids, 0.3 to 1 wt. % of a hydroxy-functional polyalkylsiloxane, 0.5 to 1.5 wt. % of leveling agent and organic solvent, the weight percentages being based on the total weight of the coating composition.

In a ninth preferred embodiment, the coating composition of the invention, comprises or consists of 20 to 30 wt. % of a mixture of soft and hard polyurethanes in a weight ratio of 1:8 to 1:10, 5 to 15 wt. % of coffee grounds or tea pigment, optionally 1 to 4 wt. % of a polyisocyanate comprising at least one isocyanurate ring, 0.05 to 0.2 wt. % of biocide and water, the weight percentages being based on the total weight of the coating composition.

In any of the afore-mentioned embodiments, the aqueous dispersion (1), the aqueous dispersion (2), the hydroxy-functional poly(meth)acrylate and the polyester polyol refer to the dispersions and resins which have been described previously in relation to suitable binders and/or the dispersing agent is copolymer comprising groups having pigment affinity and/or the leveling agent is a polyethermodified siloxane and/or the defoaming agent is a mixture of polysiloxanes and hydrophobic solids and/or the biocide is a mixture of 2-methyl-2H-isothiazol-3-on, 1,2-benzisothiazol-3(2H)-on, 5-chloro-2-methyl-4-isothiazolin-3-one, 2-methyl-4-isothiazolin-3-one. Furthermore, in any of the first to fourth afore-mentioned embodiments, the recycled carbon black pigment has a D₅₀ particle size of 15 to 25 μm or of 15 to 150 μm. The coffee grounds or tea pigment is preferably a dried coffee grounds or dried tea, in particular a dried coffee grounds or dried tea having a D₅₀ particle size of150 to 300 μm. The average particle size of the recycled carbon black, dried coffee grounds and dried tea may be determined as described previously. With particular preference, the dried coffee grounds or dried tea pigment is obtained by drying coffee grounds or tea at a temperature of 120° C. for 1 to 3 hours.

The exemplary embodiments of the coating compositions of the inventions result in high quality coatings on a wide variety of substrates, such as flexible foam materials, leather, rigid plastic substrates, etc., having a high optical quality, in particular a sufficient hiding power and a uniform appearance, as well as good mechanical properties, such as adhesion to the substrate, flexibility, weatherability, abrasion resistance etc. The optical quality of the coating layers achieved with the inventive coating compositions is comparable to the optical quality achieved with commonly used pigments, such as virgin carbon black pigments or commonly used brown pigments. If recycled carbon black is used as pigment, the visual impression of the coating layers resulting from the coating compositions can be tuned, for example by using recycled carbon black powder having different particle sizes, a pigment paste comprising recycled carbon black pigment or different amounts of recycled carbon black pigment. Additionally, coating layers containing recycled carbon black pigments having a particle size of at least 100 μm change their visual appearance, i.e. they get darker, upon mechanical influences, such as rubbing.

### Properties of the Coating Compositions of the Invention

The solids content of the coating composition may vary according to the requirements of the individual case. The solids content is guided primarily by the viscosity required for application, more particularly for spray application, and so may be adjusted by the skilled person on the basis of his or her general art knowledge, optionally with assistance from a few exploratory tests. The coating composition may have a solids content of 20 to 60 wt. %, preferably of 25 to 45 wt. %. The solids content (nonvolatile fraction) refers to the weight fraction of the residue remaining after evaporation under specified conditions, such as 130° C. for 60 minutes. In the present specification, the solids content is determined according to DIN EN ISO 3251:2019-09.

The coating composition preferably has a viscosity of 100 to 1,000 mPa*s, more preferably of 200 to 600 mPa*s, determined according to DIN EN ISO 3219:1994-10.

Depending on the particular binder(s) and crosslinking agent present in the composition of the invention, the composition of the invention is configured as a one-component system or is obtainable by mixing two (two-component system) or more (multicomponent system) components. In thermochemically curable one-component systems, the components to be crosslinked, in other words binder and crosslinking agent, are present alongside one another, in other words in one component. A condition for this is that the components to be crosslinked react with one another effectively only at relatively high temperatures, of more than 100° C., for example, so as to prevent premature at least proportional thermochemical curing. Such a combination may be exemplified by hydroxy-functional polyesters and/or polyurethanes with melamine resins and/or blocked polyisocyanates as crosslinking agents.

In thermochemically curable two-component or multicomponent systems, the components to be crosslinked, in other words binders and the crosslinking agents, are present separately from one another in at least two components, which are not combined until shortly before the application. This form is selected when the components to be crosslinked react with one another effectively even at ambient temperatures or slightly elevated temperatures of, for example, 40 to 90° C. Such a combination may be exemplified by hydroxy-functional polyesters and/or polyurethanes and/or poly(meth)acrylates with free polyisocyanates as crosslinking agents.

Where the composition of the invention is obtainable by mixing two or more components, the binder-containing component is mixed with the crosslinker-containing component.

### Method for Producing the Coating Composition

A second subject of the present invention is a method for producing a coating composition, said method comprising
(i) providing at least one pigment selected from recycled carbon black or coffee grounds or tea or providing a pigment paste comprising recycled carbon black pigment and
(ii) adding the pigment or pigment paste provided in step (i) to at least one binder and at least one solvent and optionally at least one crosslinking agent and/or at least one additive.

If the recycled carbon black pigment is used to prepare the coating composition, the coating layers resulting from said coating compositions have a “used look”, i.e. they have a lighter black color than the color obtained when using a pigment paste comprising recycled carbon black pigment. When using the pigment paste comprising recycled carbon black pigment, a comparative visual impression is obtained when compared to using pigment pastes containing virgin carbon black pigment. This allows to tune the look of the coating layer resulting from the coating composition by using the appropriate form of recycled carbon black pigment. Moreover, the color of the produced coating layers can be tuned by the amount of respective pigment, i.e. the use of lower amounts of pigment results in a lighter color than the use of higher amounts of pigment.

### Step (i)

In step (i), a recycled carbon black pigment or a coffee grounds pigment or a tea pigment or a pigment paste comprising recycled carbon black pigment is provided.

The recycled carbon black pigment can be provided by carbonizing carbon black containing waste, in particular automotive tires, milling the pyrolyzed waste, optionally pelletizing the milled waste and drying the pellets or the milled waste.

The coffee grounds pigment is preferably provided by
drying coffee grounds at a temperature of 40 to 180° C., preferably of 60 to 120° C., very preferably at 120° C., for a duration of 1 to 3 hours and
grinding the dried coffee grounds to a D₅₀ particle size of 50 to 450 μm, preferably of 100 to 400 μm, more preferably of 120 to 350 μm, very preferably of 150 to 300 μm.

The average particle size of the dried and grounded coffee grounds may be determined as previously described.

It is preferable to dry the coffee grounds at 120° C. for 1 to 3 hours because this allows a higher mildew stability as compared to using coffee grounds dried at 60° C. for 1 to 3 hours.

Grinding of the dried coffee grounds can be performed by grinding methods commonly used in the art, for example by using an industrial coffee mill.

The tea pigment is preferably provided by
drying tea leaves at a temperature of 40 to 180° C., preferably of 60 to 120° C., very preferably at 120° C., for a duration of 1 to 3 hours and
grinding the dried tea leaves to a D₅₀ particle size of 50 to 450 μm, preferably of 100 to 400 μm, more preferably of 120 to 350 μm, very preferably of 150 to 300 μm.

The average particle size of the dried and grounded tea leaves may be determined as previously described.

It is preferable to dry the tea leaves at 120° C. for 1 to 3 hours because this allows a higher mildew stability as compared to using tea leaves dried at 60° C. for 1 to 3 hours.

The pigment paste comprising recycled carbon black pigment can be provided by
mixing recycled carbon black powder with water, a dispersing agent, a defoamer, a leveling agent and optionally a pH adjustment agent,
grinding the obtained mixture, and
filtering the grinded mixture.

Grinding of the mixture can be performed by grinding methods commonly used in the art, for example by using an agitator mill. Filtering of the grinded mixture can be performed by using a filter, such as a filter with a 120 mesh size, to remove the grinding beads and to ensure a homogenous pigment paste.

To avoid incompatibilities of the pigment paste with the binder matrix, it may be beneficial to use a pH adjustment agent in an amount such that the pH of the pigment paste is in the range of 6.5 to 9, preferably of 7.5 to 8. This avoids incompatibilities with the binder matrix and ensures homogenous incorporation of the pigment paste into the binder matrix.

### Step (ii)

In step (ii) of the inventive method, the pigment or pigment paste provided in step (i) is added to the binder matrix comprising at least one binder, at least one solvent and optionally at least one crosslinking agent and/or at least one additive. If unblocked polyisocyanates are used as crosslinking agent, the crosslinking agent is only added shortly before application of the coating composition to the substrate to avoid undesired crosslinking before application. If blocked polyisocyanates are used, the crosslinking agent can be added to the binder matrix. The resulting mixture can be homogenized by stirring or by the use of commonly used dispersing methods.

What has been said about the inventive coating composition, in particular about the components of the inventive coating composition applies mutatis mutandis with respect to further preferred embodiments of the method for preparing the coating composition.

### Method for Producing a Coating on a Substrate

In the context of the method of the invention, a coating (B) is produced on a substrate (S).

As substrates (S) it is possible to use all rigid or flexible substrates known to the skilled person, examples being those composed of (i) metals, (ii) hard plastics, such as PVC, PU, PC, PA, TPU, (iii) wood, (iv) paper and card, (v) textiles, (vi) natural and synthetic leather goods, (vi) filaments made of TPU, TPA, PA, and (vii) foams. Preference in the context of the present invention is given to flexible substrates, more particularly flexible foam substrates.

Suitable foam substrates (S) include all kinds of foam substrates known in this context to the skilled person. In principle, therefore, it is possible to use foams produced from thermosets, thermoplastics, elastomers, or thermoelastics, in other words obtained by corresponding foaming processes from plastics from the stated classes of polymer. In terms of their chemical basis, possible foams include for example, but not exclusively, polystyrenes, polyvinyl chlorides, polyurethanes, polyesters, polyethers, polyetheramides, or polyolefins such as polypropylene, polyethylene, and ethylene-vinyl acetate, and also copolymers of the polymers stated. A foam substrate may of course also include a variety of the polymers and copolymers identified.

Preferred foam substrates are flexible foam substrates, especially preferably flexible thermoplastic polyurethane foam substrates. The latter, then, are foam substrates comprising thermoplastic polyurethane as their polymeric plastics matrix. A fundamental quality of such substrates is that they are compressible and elastically deformable.

In the production of the foams, the thermoplastic polyurethane is foamed—that is, converted into a foam—by corresponding foaming processes.

Foaming processes are known, and will therefore be presented only briefly. A fundamental principle in each case is that blowing agents and/or gases in solution in the plastic or in a corresponding plastics melt, and formed in crosslinking reactions in the production of corresponding polymeric plastics, are released and so bring about the foaming of the hitherto comparatively dense polymeric plastics. For example, where a low-boiling hydrocarbon is employed as a blowing agent, it vaporizes at elevated temperatures and leads to foaming. Gases such as carbon dioxide or nitrogen as well can also be introduced into the polymer melt at high pressure and/or dissolved therein, as blowing agents. As a result of a later drop in pressure, the melts then foam during the escape of the blowing agent gas.

The foaming may take place, for example, directly during shaping of corresponding plastics substrates, as for example in the course of extrusion or injection molding. The plastics melt, under pressure and with blowing agent added, may be foamed, for example, on emergence from an extruder, by virtue of the pressure drop that then occurs.

It is also possible first to produce pellets of thermoplastic, these pellets containing blowing agent, and then to foam these pellets subsequently in a mold, with the pellets increasing their volume, fusing with one another, and ultimately forming a molding consisting of fused expanded foam beads (also called thermoplastic bead foam). The expandable pellets may be formed, for example, by extrusion and subsequent pelletizing of the polymer strand exiting the extruder. Pelletization is accomplished, for example, via appropriate chopping devices, operating under pressure and temperature conditions such that no expansion occurs. The expansion that then follows and the fusing of the pellets take place in general with the aid of steam at temperatures of around 100° C.

It is also possible to start from plastics pellets that have already been prefoamed when producing thermoplastic bead foams. These are pellets whose individual pellets or polymer beads, in comparison to pellets that have not been prefoamed, already exhibit substantially increased bead sizes with correspondingly reduced densities. The production of beads with controlled prefoaming can be realized by appropriate process control, as described in WO 2013/153190 A1, for example. Hence, on exiting the extruder, extruded polymer strands may be passed into a pelletizing chamber with a stream of liquid, the liquid being under specific pressure and having a specific temperature. Through adaptation of the operating parameters, it is possible to obtain specific expanded or preexpanded thermoplastic pellets, which can be converted into thermoplastic bead foam substrates by subsequent fusing and, optionally, further expansion with—in particular—steam.

Thermoplastic bead foams and corresponding thermoplastic, expandable and/or expanded pellets from which such bead foams may be produced are described in WO 2007/082838 A1, WO 2013/153190 A1 or else WO 2008/125250 A1, for example. Also described therein are operational parameters and starting materials for the production of thermoplastic polyurethanes, and also operational parameters for the production of pellets and bead foams.

Thermoplastic bead foams, especially thermoplastic polyurethane bead foams, can be produced in a very economic way, on an industrial scale in particular and are also particularly advantageous in terms of their profile of properties. Accordingly, thermoplastic bead foams may be produced from thermoplastics, more particularly from polyurethanes, the foams exhibiting outstanding flexibility or elasticity and mechanical stability. In general they are compressible and readily elastically deformable. Accordingly, these foams especially are particularly suitable as foam substrates for applications in sectors such as the footwear industry. Especially preferred substrates, then, are compressible, elastically deformable bead foam substrates which comprise thermoplastic polyurethane as their polymeric plastics matrix.

The substrates, preferably the flexible foam substrates, may intrinsically have any desired shape—that is they may, for example, be simple sheetlike substrates or else more complex shapes such as, in particular, footwear soles such as midsoles.

In the method of the invention a colored coating (BC) is produced.

### Post-Coating Process

In a first alternative of the inventive method, a colored coating (BC) is produced by applying an inventive coating composition (C1) or a coating composition (C1) produced by the inventive method directly to the substrate (S), optionally drying the applied coating composition (C1) to form a coating film and curing the applied coating composition (C1) or the formed coating film. This method is also called post-coating process, because the coating of the substrate (S) is performed after production of the substrate (S).

Preferred aqueous coating compositions used in the first alternative of the inventive method contain a mixture of different aqueous dispersions containing at least one polyurethane resin fraction.

Even though no pre-treatment of the substrate, for example by using coating materials such as adhesion primers, has been performed, an outstanding adhesion is achieved as part of the method of the invention. Refraining from applying such coating materials before applying the coating composition (C1) results in a massive simplification of the method.

The coating composition (C1) may be applied by the methods known to the skilled person for applying liquid coating compositions, as for example by dipping, knife coating, spraying, rolling, or the like. Preference is given to employing spray application methods, such as compressed air spraying (pneumatic application), airless spraying, high-speed rotation, electrostatic spray application (ESTA), optionally in conjunction with hot spray application such as hot air (hot spraying), for example. With very particular preference the aqueous coating compositions are applied by pneumatic spray application or electrostatic spray application. Such application may take place in the form of single application or else multiple application, an example being dual application.

The application may be performed manually, via semi-automatic spraying equipment or via an automatic spraying device. Such spraying equipment is commonly known in the state of the art and sold, for example, by SATA GmbH & Co. KG or OERTER GmbH & Co. KG.

The applied coating composition (C1) is preferably dried a temperature of 15 to 60° C., more preferably of 20 to 30° C., for a duration of 1 to 30 minutes, preferably of 3 to 20 minutes to form a coating film.

The dried coating film or—in case no drying is performed—the applied coating composition (C1) is then cured to produce a colored coating (BC), i.e., a cured colored coating film. Curing takes place preferably at temperatures between 40 and 120° C., more preferably between 60 and 100° C., for a time of, for example, 10 to 60 minutes, preferably 15 to 35 minutes. In this way, decomposition or deformation of preferred substrates, in particular foam substrates, is avoided.

According to a particularly preferred embodiment of the inventive method, no further coating other than the colored coating (BC) is produced on the substrate, i.e. the substrate only comprises the colored coating (BC).

### In-Mold Coating Process

According to a second alternative of the inventive method, a colored coating (BC) is produced by
applying the inventive coating composition (C1) or a coating composition (C1) produced by the inventive method to at least one inner surface of a mold and optionally drying the applied coating composition (C1),
applying a composition forming the substrate (S) into the mold,
forming the substrate (S) while simultaneously curing the coating composition (C1), and
removing the coated substrate from the mold.

The inner surface of the mold refers to the surface which comes into contact with the composition forming the substrate (S).

With particular preference, the inventive coating composition used in this alternative comprises a mixture of ethoxylated fatty acids and fatty alcohols as well as an hydroxy-functional polyalkylsiloxane to facilitate removal of the coated substrate from the mold, i.e. to prevent damage of the coated substrate (S). This alternative of the inventive process allows to produce coated substrates during the production of the substrate, thus rendering a further post-coating step superfluous.

The coating composition (C1) can be applied to the mold surface as previously described and is preferably dried for less than 2 min, more preferably less than 1 min, and very preferably less than 30 s prior to applying the composition forming the substate into the mold. In this case it is advantageous if the molding tool possesses a temperature of 20 to 100° C., more preferably 30 to 90° C., very preferably 40 to 80° C., more particularly 50 to 70° C.

Suitable compositions for forming the substrate (S) include reactive compositions, i.e. chemically curable compositions, such as reactive foam compositions, or non-crosslinkable compositions, for example the previously mentioned expanded or expandable polyurethane particles. These compositions may be injected into the closed mold or may be applied in the open mold. In the latter case, the mold is closed prior to forming the substrate (S) while simultaneously curing the coating composition (C1). Prior to applying the composition forming the substrate, further compositions or materials may be inserted into the mold. This allows to produce substrates being prepared from at least two different materials.

Formation of the substrate (S) and curing of the coating composition (C1) preferably takes place for 1 to 30 min, typically 5 to 20 min, at a molding tool temperature in the range from 45 to 75° C., more preferably from 50 to 70° C.

The coated substrate can be post-coated using commonly known basecoat and clearcoat compositions. However it is preferred if no further coating layer is applied onto the coated substrate obtained after removing the coated substrate from the mold.

### Transfer-Coating Process

According to a third alternative of the inventive method, a colored coating (BC) is produced by
applying the inventive coating composition (C1) or a coating composition (C1) produced by the inventive method to a structured matrix or mold and curing the applied coating composition (C1),
forming a bonding layer on the cured coating composition (C1),
applying a substrate to the bonding layer, and
removing the formed coated substrate from the matrix or mold.

The coating composition (C1) can be applied to the matrix or mold as previously described. Suitable methods to prepare structure matrices or molds are well known in the state of the art and are, for example, described in published patent application US 2010/0330333 A1. Preferred coating compositions (C1) used in the third alternative comprise a mixture of soft and hard polyurethanes.

Curing of the applied coating composition (C1) can be performed at 60 to 90° C. for 1 to 10 minutes, preferably for 1 to 5 minutes.

The bonding layer may comprise an interrupted, i.e., discontinuous, layer, preferably of a cured organic adhesive or a continuous layer of a cured organic adhesive. The discontinues layer may have the form of points, stripes, lattices, rectangles, squares, honeycomb structure, etc.

In one example, the bonding layer may comprise a layer of a cured organic adhesive, for example based on polyvinyl acetate, polyacrylate or in particular polyurethane, preferably based on polyurethanes having a glass transition temperature below 0° C. The organic adhesive may for example be cured thermally, through actinic radiation or by aging. In another example, the bonding layer comprises an adhesive gauze.

The substrate may be a textile, such as a woven or non-woven textile or may be a polymeric material, such as an extruded polymer film or a cured polymer film.

What has been said about the inventive coating composition, in particular about the components of the inventive coating composition, and about the inventive method to prepare the coating compositions applies mutatis mutandis with respect to further preferred embodiments of the method for producing a coating (B) on a substrate (S).

### Coating of the Invention

The result after the end of the inventive method is a coating (B) of the invention. With preference the coating (B) consists exclusively of the colored coating (BC).

The produced coating has a high optical quality, especially a sufficient hiding power to hide the underlying substrate and a uniform color, as well as good mechanical properties, such as a high adhesion to the underlying substrate, a high flexibility, a good weathering stability and a high abrasion resistance. The high optical quality and the good mechanical stability is achieved irrespective of the substrate and the carrier of the coating composition (i.e. water or organic solvents), thus allowing to use a wide variety of different substrates as well as tailoring the coating composition to the specific needs of the process to produce the coated substrate. Additionally the produced coating can be tuned with respect to optical properties, thus allowing to achieve the look desired by the customers via use of the sustainable pigments, in particular recycled carbon black pigment, in the appropriate form, i.e. as powder or as pigment paste. Finally, the coating produced when using recycled carbon black pigment as powder changes its appearance depending on the mechanical influence, such as abrasion, thus allowing to create desired optical effects using mechanical influence.

What has been said about the inventive coating composition, about the inventive method to prepare the coating compositions and about the inventive process to produce a coating on a substrate applies mutatis mutandis with respect to further preferred embodiments of the inventive coating.

### Substrate of the Invention

A final subject of the invention is a substrate bearing an inventive coating.

What has been said about the inventive coating composition, the inventive method to prepare the coating compositions, about the inventive process to produce a coating on a substrate and about the inventive coating applies mutatis mutandis with respect to further preferred embodiments of the inventive substrate.

The invention is described in particular by the following embodiments:

1. A coating composition comprising:
a) at least one binder,
b) at least one pigment selected from recycled carbon black or coffee grounds or tea,
c) at least one solvent,
d) optionally at least one crosslinking agent, and
e) optionally at least one additive.
   2. Coating composition according to embodiment 1, wherein the at least one binder is selected from the group consisting of (i) poly(meth)acrylates, more particularly hydroxy-functional and/or carboxylate-functional al and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof, preferably from polyurethanes, dispersions containing a polyurethane resin fraction containing polyurethane resin(s), poly(meth)acrylates, polyester polyols and mixtures thereof.
   3. Coating composition according to embodiment 1 or 2, wherein the composition comprises a soft polyurethane (PU1) having a shore hardness of less than 60, and a hard polyurethane (PU2) having a shore hardness of above 60 to 100, the shore hardness being determined according to DIN 53505:2000-08 after 3 s.
   4. Coating composition according embodiment 3, wherein the weight ratio of the soft polyurethane PU1 to the hard polyurethane PU2 is from 1:1 to 1:20, preferably of 1:5 to 1:15, very preferably of 1:8 to 1:12.
   5. Coating composition according to embodiment 1 or 2, wherein the composition comprises at least one hydroxy-functional poly(meth)acrylate and at least one polyester polyol, in particular a branched polyester polyol.
   6. Coating composition according to embodiment 5, wherein the weight ratio of the hydroxy-functional poly(meth)acrylate to the polyester polyol is from 2:1 to 1:2, preferably 1.5:1 to 1:1.5, very preferably 1 to 1.2 to 1:1.4.
   7. Coating composition according to embodiment 1 or 2, wherein the composition comprises at least one aqueous dispersion (1) comprising water and a polyurethane resin fraction consisting of at least one polyurethane resin, the polyurethane resin fraction having a gel fraction of at least 50 wt. %, having its glass transition at a temperature of less than −20° C., and having its melting transition at a temperature of less than 100° C., and at least one aqueous dispersion (2) comprising water and a polyurethane resin fraction consisting of at least one polyurethane resin, the polyurethane resin fraction of the aqueous dispersion (2) possessing a gel fraction of at least 50% and being present in the form of dispersed particles having an average particle size (volume average) of 20 to 500 nanometers
   8. Coating composition according to embodiment 7, wherein the polyurethane resin fraction of the at least one aqueous dispersion (1) has its glass transition at a temperature in the range from −100° C. to less than-20° C., has its melting transition at a temperature in the range from −20° C. to less than 90° C., and comprises particles having a particle size of greater than 1 micrometer.
   9. Coating composition according to embodiment 7 or 8, wherein the weight ratio of the resin fraction in the aqueous dispersion (1) to the second polyurethane resin fraction in the aqueous dispersion (2) is 5:1 to 1:5, preferably 3:1 to 1:3, very preferably 2:1 to 1.5:1.
   10. Coating composition according to any one of the preceding embodiments, wherein the at least one binder is present in a total amount of 5 to 50 wt. % solids, preferably of 10 to 40 wt. % solids, very preferably of 20 to 35 wt. % solids, based in each case on the total weight of the coating composition.
   11. Coating composition according to any one of the preceding embodiments, wherein the recycled carbon black pigment has a D₅₀ particle size of 1 to 150 μm, preferably of 5 to 35 μm, more preferably of 10 to 30 μm, very preferably of 15 to 25 μm, as determined according to DIN EN ISO 21363:2022-03.
   12. Coating composition according to any one of the preceding embodiments, wherein the recycled carbon black pigment is present in a total amount of 0.1 to 10 wt. %, preferably of 0.3 to 8 wt. %, more preferably of 0.5 to 6 wt. %, very preferably of 1 to 4 wt. %, based in each case on the total weight of the coating composition.
   13. Coating composition according to any one of the preceding embodiments, wherein the tea pigment is selected from dried and optionally grinded green tea, black tea or rooibos tea.
   14. Coating composition according to any one of the preceding embodiments, wherein the coffee grounds pigment is a dried coffee grounds pigment or wherein the tea pigment is a dried tea pigment.
   15. Coating composition according to embodiment 14, wherein the dried coffee grounds pigment or the dried tea pigment is obtained by drying coffee grounds or tea, in particular green tea, black tea or rooibos tea, at a temperature of 40 to 180° C., preferably of 60 to 120° C., very preferably at 120° C., for a duration of 1 to 3 hours and grinding the dried coffee grounds or the dried tea.
   16. Coating composition according to embodiment 14 or 15, wherein the dried coffee grounds or the dried tea has a D₅₀ particle size of 50 to 450 μm, preferably of 100 to 400 μm, more preferably of 120 to 350 μm, very preferably of 150 to 300 μm as determined according to DIN EN ISO 1524:2020-11.
   17. Coating composition according to any one of the preceding embodiments, wherein the coffee grounds or tea pigment, preferably the dried coffee grounds or tea pigment, is each present in a total amount of 0.1 to 25 wt. %, preferably of 1 to 20 wt. %, more preferably of 5 to 15 wt. %, very preferably of 8 to 12 wt. %, based in each case on the total weight of the coating composition.
   18. Coating composition according to any one of the preceding embodiments, wherein the coating composition comprises—apart from the recycled carbon black pigment or coffee grounds pigment or tea pigment—0 wt. %, based on the total weight of the coating composition, of further pigments and/or fillers and/or dyes.
   19. Coating composition according to any one of the preceding embodiments, wherein the crosslinking agent is selected from amino resins, unblock polyisocyanates, at least partially blocked polyisocyanates, polycarbodiimides, UV light, heat, photoinitiators, and mixtures thereof, in particular unblocked polyisocyanates and polycarbodiimides.
   20. Coating composition according to embodiment 19, wherein the unblocked polyisocyanate is selected from (i) polyisocyanates containing at least one iminooxadiazinedione ring or polyisocyanates containing at least one isocyanurate ring or a mixture of such polyisocyanates, (ii) polyether-modified polyisocyanates, and (iii) mixtures thereof.
   21. Coating composition according to any one of the preceding embodiments, wherein the crosslinking agent is present in a total amount of 1 wt. % to 40 wt. % solids, preferably of 2 to 30 wt. % solids, more particularly of 6 to 12 wt. % or 15 to 25 wt. % solids, based in each case on the total weight of the coating composition
   22. Coating composition according to any one of the preceding embodiments, wherein the at least one additive is selected from the group of dispersing agents, leveling agents, pH adjustment agents, defoaming agents, biocides, UV absorbers, crosslinking catalysts, ethoxylated fatty alcohols, fatty acids, polyethermodified polyalkylsiloxanes, hydroxy-functional polyalkylsiloxanes and mixtures thereof.
   23. Coating composition according to embodiment 22, wherein the at least one dispersing agent is selected from (i) polycarboxylate ethers, (ii) poly(meth)acrylates, (iii) polyvinyls, (iv) copolymers, in particular block copolymers comprising a polycarboxylate ether, a poly(meth)acrylate, a polyvinyl, and any mixtures thereof; or (v) mixtures of the aforementioned polymers and copolymers, in particular from anionic copolymers comprising a polymethacrylate and a polyvinyl.
   24. Coating composition according to embodiment 22 or 23, wherein the at least one dispersing agent is present in a total amount of 0.1 to 10 wt. %, preferably of 0.5 to 6 wt. %, very preferably of 1 to 3 wt. %, based in each case on the total weight of the coating composition.
   25. Coating composition according to any one of embodiments 22 to 24, wherein the at least one leveling agent is selected from nonionic, cationic or anionic surfactants, in particular from nonionic acetylenic diol compounds.
   26. Coating composition according to any one of embodiments 22 to 25, wherein the at least one leveling agent is present in a total amount of 0 wt. % or of 0.02 to 3 wt. %, based in each case on the total weight of the coating composition.
   27. Coating composition according to any one of embodiments 22 to 26, wherein the at least one pH adjustment agent is selected from inorganic and organic bases, in particular from organic nitrogen containing bases, very preferably from N,N-dimethylethanolamine.
   28. Coating composition according to any one of embodiments 22 to 27, wherein the at least one defoaming agent is selected from polysiloxanes, hydrophobic solids, polyethermodified siloxanes, polyether siloxane copolymers and mixtures thereof.
   29. Coating composition according to any one of embodiments 22 to 28, wherein the at least one defoaming agent is present in a total amount of 0.02 to 1.5 wt. %, based in each case on the total weight of the coating composition.
   30. Coating composition according to any one of embodiments 22 to 29, wherein the at least one biocide is selected from methylisothiazolon, benzisothiazolon, chloro methylisothiazolon, methylisothiazolinone and mixtures thereof, in particular from 2-methyl-2H-isothiazol-3-on, 1,2-benzisothiazol-3(2H)-on, 5-chloro-2-methyl-4-isothiazolin-3-one, 2-methyl-4-isothiazolin-3-one and mixtures thereof.
   31. Coating composition according to any one of embodiments 22 to 30, wherein the at least one biocide is present in a total amount of 0.05 to 0.3 wt. %, based in each case on the total weight of the coating composition.
   32. Coating composition according to any one of the preceding embodiments, wherein the coating composition has a viscosity of 100 to 1,000 mPa*s, preferably of 200 to 600 mPa*s, as determined according to DIN EN ISO 3219:1994-10.
   33. A method for producing a coating composition, said method comprising
(i) providing at least one pigment selected from recycled carbon black or coffee grounds or tea or providing a pigment paste comprising recycled carbon black pigment and
(ii) adding the pigment or pigment paste provided in step (i) to at least one binder and at least one solvent and optionally at least one crosslinking agent and/or at least one additive.
   34. The method according to embodiment 32, wherein the recycled carbon black pigment is provided by carbonizing carbon black containing waste, in particular automotive tires, milling the pyrolyzed waste, optionally pelletizing the milled waste and drying the pellets or the milled waste.
   35. The method according to embodiment 32 or 33, wherein the coffee grounds pigment is provided by
drying coffee grounds at a temperature of 40 to 180° C., preferably of 60 to 120° C., very preferably at 120° C., for a duration of 1 to 3 hours and
grinding the dried coffee grounds to a D₅₀ particle size of 50 to 450 μm, preferably of 100 to 400 μm, more preferably of 120 to 350 μm, very preferably of 150 to 300 μm, as determined according to DIN EN ISO 1524:2020-11.
   36. The method according to any one of embodiments 32 to 34, wherein the tea pigment is provided by
drying tea leaves at a temperature of 40 to 180° C., preferably of 60 to 120° C., very preferably at 120° C., for a duration of 1 to 3 hours and
grinding the dried tea leaves to a D₅₀ particle size of 50 to 450 μm, preferably of 100 to 400 μm, more preferably of 120 to 350 μm, very preferably of 150 to 300 μm, as determined according to DIN EN ISO 1524:2020-11.
   37. The method according to any one of embodiments 32 to 35, wherein the pigment paste comprising recycled carbon black is provided by
mixing recycled carbon black powder with water, a dispersing agent, a defoamer, a leveling agent and optionally a pH adjustment agent,
grinding the obtained mixture, and
filtering the grinded mixture.
   38. The method according to embodiment 36, wherein the pH is adjusted to 6.5 to 9, preferably to 7.5 to 8.
   39. A method for producing a coating (B) on a substrate (S), comprising a step of producing a colored coating (BC) directly on the substrate (S) by applying a coating composition (C1) according to any one of embodiments 1 to 31 or a coating composition (C1) prepared according to the method claimed in any one of embodiments 32 to 37 directly to the substrate (S), optionally drying the applied coating composition (C1) to form a coating film and curing the applied coating composition (C1) or the formed coating film.
   40. The method according to embodiment 38, wherein the applied coating composition (C1) is dried at a temperature of 15 to 60° C., preferably of 20 to 30° C., for a duration of 1 to 30 minutes, preferably of 3 to 20 minutes.
   41. The method according to embodiment 29 or 32, wherein the coating composition (C1) is cured at a temperature of 40 and 120° C., preferably 60 to 100° C., for a duration of 10 to 60 minutes, preferably 15 to 35 minutes.
   42. A method for producing a coating (B) on a substrate (S), comprising
a step of producing a colored coating (BC) directly on the substrate (S) by applying a coating composition (C1) according to any one of embodiments 1 to 31 or a coating composition (C1) prepared according to the method claimed in any one of embodiments 32 to 37 to at least one inner surface of a mold and optionally drying the applied coating composition (C1),
applying a composition forming the substrate (S) into the mold,
forming the substrate (S) while simultaneously curing the coating composition (C1), and
removing the coated substrate from the mold.
   43. The method according to embodiment 41, wherein the applied coating composition (C1) is dried at a temperature of 20 to 100° C., more preferably 30 to 90° C., very preferably 40 to 80° C., more particularly 50 to 70° C., for a duration of less than 2 min, more preferably less than 1 min, and very preferably less than 30 s.
   44. The method according to embodiment 41 or 42, wherein the coating composition (C1) is cured at a temperature of 45 to 75° C., more preferably from 50 to 70° C., for a duration of 1 to 30 minutes, typically 5 to 20 minutes.
   45. A method for producing a coating (B) on a substrate (S), comprising
a step of producing a colored coating (BC) directly on the substrate (S) by applying a coating composition (C1) according to any one of embodiments 1 to 31 or a coating composition (C1) prepared according to the method claimed in any one of embodiments 32 to 37 to a structured matrix or mold and curing the applied coating composition (C1),
forming a bonding layer on the cured coating composition (C1),
applying a substrate to the bonding layer, and
removing the formed coated substrate from the matrix or mold.
   46. The method according to embodiment 44, wherein the applied coating composition (C1) is cured at a temperature of 60 to 90° C. for a duration of 1 to 10 minutes, preferably for 1 to 5 minutes.
   47. The method according to any one of embodiments 38 to 45, wherein no further coating other than the colored coating is produced.
   48. The method according to any one of embodiments 38 to 46, wherein the substrate (S) comprises a (i) metals, (ii) hard plastics, such as PVC, PU, PC, PA, TPU, (iii) wood, (iv) paper and card, (v) textiles, (vi) natural and synthetic leather goods, (vi) filaments made of TPU, TPA, PA, and (vii) foams, in particular a a flexible substrate, more preferably a flexible foam substrate, even more preferably a thermoplastic polyurethane bead foam substrate.
   49. A coating produced by the method as claimed in any of embodiments 29 to 33.
   50. A substrate bearing a coating as claimed in embodiment 34.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

### 1. Measurement Methods

### 1.1 Gel Fraction

The gel fraction, in particular of polyurethane resin fractions of corresponding aqueous dispersions, is determined gravimetrically in the context of the present invention. Here, first of all, the polymer present was isolated from a sample of an aqueous dispersion (initial mass 1.0 g) by freeze-drying. Following determination of the solidification temperature—the temperature above which the electrical resistance of the sample shows no further change when the temperature is lowered further—the fully frozen sample underwent its main drying, customarily in the drying vacuum pressure range between 5 mbar and 0.05 mbar, at a drying temperature lower by 10° C. than the solidification temperature. By graduated increase in the temperature of the heated surfaces beneath the polymer to 25° C., rapid freeze-drying of the polymers was achieved; after a drying time of typically 12 hours, the amount of isolated polymer (solid fraction, determined by the freeze-drying) was constant and no longer underwent any change even on prolonged freeze-drying. Subsequent drying at a temperature of 30° C. of the surface beneath the polymer, with the ambient pressure reduced to the maximum degree (typically between 0.05 and 0.03 mbar), produced optimum drying of the polymer.

The isolated polymer was subsequently sintered in a forced air oven at 130° C. for one minute and thereafter extracted for 24 hours at 25° C. in an excess of tetrahydrofuran (ratio of tetrahydrofuran to solid fraction=300:1). The insoluble fraction of the isolated polymer (gel fraction) was then separated off on a suitable frit, dried in a forced air oven at 50° C. for 4 hours, and subsequently reweighed.

It was further ascertained that at the sintering temperature of 130° C., with variation in the sintering times between one minute and twenty minutes, the gel fraction found for the microgel particles is independent of the sintering time. It can therefore be ruled out that crosslinking reactions subsequent to the isolation of the polymeric solid increase the gel fraction further.

Given that some of the aqueous, commercially acquired polymer dispersions used additionally include inorganic components such as silicates, and the fraction of these inorganic components is of course captured as well in the determination of the gel fraction, all of the dispersions were incinerated (800° C.) and any remaining ash content was then subtracted from the gel fraction found.

### 1.2 Glass Transition and Melting Transition

The glass transition is determined on the basis of the glass transition temperature. The glass transition temperature in the context of the invention is determined experimentally in a method based on DIN 51005 “Thermal Analysis (TA)—Terms” and DIN 53765 “Thermal Analysis—Differential Scanning calorimetry (DSC)”. A sample of the binder is applied with a wet film thickness of 100 μm, using a doctor blade, to a glass plate, dried initially at 40° C. for 1 hour and then dried at 110° C. for 1 hour. For the measurement, a section of the film thus dried is removed from the glass plate and inserted into the measuring sleeve. This sleeve is then inserted into a DSC instrument. It is cooled to the start temperature, after which 1^{st} and 2^{nd} measurement runs are carried out at a heating rate of 10 K/min with inert gas flushing (N₂) of 50 ml/min, with cooling again to the start temperature between the measurement runs.

A glass transition can be seen in the DSC diagram as a section of the measurement curve that in terms of amount possesses a slope much greater in relation to the baselines before and after the transition. The slope greater in terms of amount is known to be attributable to the higher quantity of energy needed in the region of the phase transition in order to increase the temperature. A measurement curve section of this kind then, of course, possesses a point of inflection in the region with the slope that is greater in terms of amount. For the purposes of the present invention, the glass transition temperature of a glass transition is taken to be the temperature of this point of inflection in the 2^{nd} measurement run.

The temperature at which the polyurethane resin fraction has its glass transition is defined as follows in the context of the present invention: it is the temperature at the point of inflection of the curve section assignable to the glass transition (glass transition temperature). It is possible for there to be a number of curve sections present which can be assigned to glass transitions. The system in question in that case has a number of glass transitions and glass transition temperatures. In such an event, the temperature at which the polyurethane resin fraction has its glass transition is the temperature at the point of inflection of the curve section in the highest temperature range. In such an event, indeed, it is only after the last glass transition that there is no longer any glasslike structure at all in the corresponding polyurethane resin fraction. The expression “its glass transition” can therefore be equated with the wording “its complete glass transition” or “its glass transition with the highest temperature”.

The melting transition is likewise determined from the DSC diagram measured as described above. A melting transition is seen as a region which deviates from the baseline in the DSC diagram. Within this region, in fact, the system must be supplied with a greater quantity of energy, owing to the phase conversion of the crystallites, in order to bring about an increase in temperature. These regions, as is known, are seen as peaks with different widths.

The temperature at which the polyurethane resin fraction has its melting transition is defined as follows in the context of the present invention: it is the temperature at the extreme point of the peak assignable to the melting transition. Where there are a number of peaks present to which melting transitions are assignable, the extreme point in question is that of the peak in the highest temperature range. In such an event, indeed, the system has a number of melting transitions. Accordingly, there is no longer any crystalline structure present in the corresponding polyurethane resin fraction only after the last melting transition. The expression “its melting transition” can therefore be equated with the wording “its complete melting transition” or “its melting transition with the highest temperature”.

### 2. Methods of Determination

### 2.1 Migration Test

The migration test is performed according to DIN EN ISO 15701:2015-07. In this test method, the side of the sample coated with the respective coating layer is placed in contact with a standardized PVC material described in the official standard under a defined pressure for 16 hours at 50° C.±2° C. After a set cooling period of 2 h, bleeding of the contact materials is assessed by comparison with a greyscale (grade 1 to 5, grade 1=high migration, grade 5=no migration). This is accomplished by comparison of the contrast values between that part of the PVC material which was in contact with the coating layer and a part of the same PVC material which did not come into contact with the coating layer.

### 2.2 Rapid Aging Test

The rapid aging test is performed to determine the change in visual properties through artificial aging according to DIN EN ISO 2440:2020-03 (method A). After the end of the rapid aging test, the samples were conditioned for 24 h at 23° C. and 50% relative humidity and visually compared to untreated samples (i.e. samples not hydrolysis tested) for color change using a greyscale (grade 1 to 5, grade 1=large color change, grade 5=no color change).

### 2.3 Fatigue Bending Test

The coated substrate was bend (60° bend) centrally with the coated side outward for a minimum of 50.000 cycles. The coated substrates were subsequently visually inspected for cracks. If all occurring cracks were <1 mm, the coated substrate was rated as “pass”, otherwise the coated substrate was rated as “fail”.

### 2.4 Light Fastness

The light fastness was determined by partially covering the coating layer of the coated substrates and exposing the partially covered coating layer to outdoor conditions in an Atlas SUNTEST XLS+ having an uncoated quartz filter for 6 hours. Afterwards, the contrast between the covered and non-covered part of the coated substrate is compared using a greyscale (1 to 5, grade 1=huge contrast, grade 5=no contrast).

### 2.5 Rubbing Fastness

The rubbing fastness was tested by rubbing sandpaper 280 for 25 times (back and forth) with a defined pressure of 1 kg over the coated substrates. The coated substrates were subsequently inspected for visual defects. If no visual defects were present in the coating layer the coated substrate was rated as “pass”, otherwise the coated substrate was rated as “fail”.

### 2.6 Hiding Power

The hiding power was determined visually by inspection of the coated substrate. If the underlying color of the substrate is not visible, the coated substrate is rated as “pass”, otherwise the coated substrate is rated as “fail”

### 2.7 Uniformity of Color of Coating Layer

The uniformity of the color of the coating layer was determined visually by inspection of the coated substrate. If coating layer has a uniform color (i.e. no visual color differences or defects in the coating layer), the coated substrate is rated as “pass”, otherwise the coated substrate is rated as “fail”

### 3. Coating Compositions

### 3.1 Preparation of Pigment Pastes Containing Recycled Carbon Black

The pigment pastes P1 and P2 each containing carbon black were prepared by mixing the ingredients listed in Table 1 and grinding the ingredients using agitator mill for 4 to 6 hours. Afterwards, the obtained grinded mixture was filtered using a 120 mesh filter.

TABLE 1
Ingredients used to prepare pigment pastes P1 and P2 comprising
recycled carbon black (all amounts are given in wt. %)

| | Pigment paste P1 | Pigment paste P2 |
|---|---|---|
| Recycled carbon black ¹⁾ | 35.0 | 20.0 |
| Distilled water | 50.0 | 64.2 |
| Dispersing agent 1 ²⁾ | 15.0 | — |
| Dispersing agent 2 ³⁾ | — | 15.0 |
| Defoamer 1 ⁴⁾ | 0.400 | — |
| Defoamer 2 ⁵⁾ | — | 0.100 |
| Leveling agent ⁶⁾ | — | 0.500 |
| pH adjustment agent ⁷⁾ | — | 0.200 |

¹⁾ D₅₀ particle size = 15 to 25 μm, determined by DIN EN ISO 21363: 2022-03 (supplied by Black Bear, the Netherlands)
²⁾ Dispex ® Ultra PX 4290 (BASF SE)
³⁾ TEGO ® Dispers 755 W (Evonik Industries AG)
⁴⁾ BYK 022 (BYK Chemie GmbH)
⁵⁾ TEGO ® Foamex 810 (Evonik Industries AG)
⁶⁾ SURFYNOL ® 104 BC (Evonik Industries AG)
⁷⁾ N,N-dimethylethanolamin

### 3.2 Preparation of Base Components

The following base components BC1-1 to BC1-3 were produced by dispersing the pigment paste P1 or the recycled carbon black pigment or the coffee grounds pigment in a binder matrix obtained by mixing the aqueous polyurethane dispersions with the leveling agent and the biocides where appropriate.

TABLE 2a
Ingredients used to prepare base components BC-1 to BC-3

| | BC1-1 | BC1-2 | BC1-3 |
|---|---|---|---|
| Aqueous dispersion (1) ¹⁾ | 64.8 | 70.4 | 64.7 |
| Frist aqueous dispersion | 21.3 | 23.0 | 21.3 |
| (2) ²⁾ | | | |
| Second aqueous | 3.93 | 4.27 | 3.93 |
| dispersion (3) ³⁾ | | | |
| Pigment paste P1 | 10.0 | — | — |
| Recycled carbon black ⁴⁾ | — | 1.30 | — |
| Coffee grounds ⁵⁾ | — | — | 10.0 |
| Leveling agent ⁶⁾ | — | 1.00 | — |
| Biocide 1 ⁷⁾ | — | — | 0.100 |
| Biocide 2 ⁸⁾ | — | — | 0.050 |

¹⁾ commercial dispersion (1) comprises a polyurethane resin fraction with a gel fraction of 61.3%. The polyurethane resin fraction has its glass transition at a temperature of −47° C. and its melting transition at a temperature of 50° C. The polyurethane resin fraction comprises particles having a particle size of 1 to 100 micrometers. The solids content of the dispersion is 26.5% including 1.8% of inorganic components (silicates) (determined via incineration, 800° C.),
²⁾ first commercial dispersion (2) comprises a polyurethane resin fraction having a gel fraction of 91%. The average particle size (volume average)is 244 nanometers. The polyurethane resin fractions have their glass transition at −48° C. Melting transitions at below 100° C. are not observed. The solids contents of the dispersion is 39.0%.,
³⁾ second commercial dispersion (2) comprises a polyurethane resin fraction having a gel fraction of 95%. The average particle size (volume average)is 56 nanometers. The polyurethane resin fractions have their glass transition at −60° C. Melting transitions at below 100° C. are not observed. The solids contents of the dispersions are 37.0%,
⁴⁾ D₅₀ particle size = 15 to 25 μm, determined by DIN EN ISO 21363: 2022 March (supplied by Black Bear, the Netherlands),
⁵⁾ prepared by drying coffee grounds at 120° C. for 2 hours and grinding the dried coffee
grounds to a D₅₀ particle size of 150 to 300 μm as determined according to DIN EN ISO 1524; 2020 November,
⁶⁾ BYK 346 (supplied by BYK Chemie GmbH),
⁷⁾ Acitcide MSB 5050 (supplied by THOR GmbH),
⁸⁾ Kathon ™ LX-150 Biocide (supplied by Dow)

### 3.3 Hardener Component

The commercially available product Astacin® Härter CI (polyether-modified HDI-Isocyanurate, NCO content=11%, solids content=70% (supplied by BASF SE) was used as hardener component.

### 3.3 Preparation of Inventive Aqueous Coating Compositions AC1-1 to AC1-3

The respective inventive aqueous coating composition AC1-1 to AC1-3 was obtained by mixing the respective base component BC1-1 to BC1-3 homogeneously with the hardener component in a weight ratio of 100 (base component):8 (hardener component) immediately before application of the respective aqueous inventive coating composition to the substrate as described hereinafter.

### 4. Production of Coated Substrates

### 4.1 Substrate

Polyurethane bead foam sheets with a thickness of 1 cm were prepared by expanding and fusing corresponding polyurethane pellets in corresponding molds by means of steam.

### 4.2 Coating of Substrates

The respective aqueous coating composition AC-1 to AC-3 was each applied directly to the substrate prepared in point 3.1 in a one-coat system (pneumatic manual coating) and dried for 4 to 5 minutes at 23° C. The dried coating compositions are cured in a forced air oven at 80° C. for 20 minutes. The film thicknesses (cured) were in each case 20-25 micrometers.

The following coated substrates were produced (Table 3):

TABLE 3
Produced coated substrates

Substrate

| | S1 | S2 | S3 |
|---|---|---|---|
| Aqueous coating composition | AC1-1 | AC1-2 | AC1-3 |

### 5. Results

### 5.1 Migration Test

The migration tendency of substances being present in the colored coating layers on substrates S1 to S3 is determined as described in point 1.1 above. The results are shown in Table 4.

TABLE 4
Results migration test

Substrate

| | S1 | S2 | S3 |
|---|---|---|---|
| Rating migration test | 4-5 | 4-5 | 4-5 |

Each coating layer produced from aqueous coating compositions AC1-1 to AC1-3 containing sustainable pigments (i.e. recycled carbon black or dried coffee grounds) directly on the expanded and fused TPU bead substrate does not show any or only a slight migration to a substrate being in contact with the respective coating layer and thus fulfils the requirements regarding the migration test for colored clothing, such as footwear, coming into contact with human skin.

### 5.2 Rapid Aging Test

The color change upon ageing of the coated substrates S1 to S3 is determined as described in point 1.2 above. The results are shown in Table 5.

TABLE 5
Results rapid aging test

Substrate

| | S1 | S2 | S3 |
|---|---|---|---|
| Rating rapid aging test | 4 | 4 | 4 |

Each coating layer produced from aqueous coating compositions AC1-1 to AC1-3 containing sustainable pigments (i.e. recycled carbon black or dried coffee grounds) directly on the expanded and fused TPU bead substrate does not show any significant color change upon aging, thus allowing to produce coating layers having an excellent weathering stability.

### 5.3 Fatigue Bending Test

The fatigue bending of coated substrates S1 to S3 is determined as described in point 1.3 above. The results are shown in Table 6.

TABLE 6
Results fatigue bending test

Substrate

| | S1 | S2 | S3 |
|---|---|---|---|
| Rating fatigue bending test | Pass | Pass | Pass |

Each coating layer produced from aqueous coating compositions AC1-1 to AC1-3 containing sustainable pigments (i.e. recycled carbon black or dried coffee grounds) on the expanded and fused TPU bead substrate shows a sufficient flexibility to prevent the formation of significant cracks upon bending of the coated substrates S1 to S3, thus rendering the aqueous coating compositions AC-1 to AC-3 especially suitable for the coating of flexible substrates which are bend numerous times during their life-time, such as flexible foam materials used as midsoles in the footwear industry.

### 5.4 Light Fastness

The light fastness against sunlight of coated substrates S1 to S3 is determined as described in point 1.4 above. The results are shown in Table 7.

TABLE 7
Results light fastness test

Substrate

| | S1 | S2 | S3 |
|---|---|---|---|
| Rating light fastness test | 4 | 4 | 4 |

Each coating layer produced from aqueous coating compositions AC1-1 to AC1-3 containing sustainable pigments (i.e. recycled carbon black or dried coffee grounds) on the expanded and fused TPU bead substrate shows a sufficient light fastness, i.e. does not show a significant color change upon irradiation of the coated substrate with sunlight. Thus, the inventive aqueous coating compositions result in colored coating layers having a high weathering stability and are thus suitable for substrates coming into contact with sunlight, such as clothing worn outside.

### 5.5 Rubbing Fastness

The rubbing fastness of coated substrates S1 to S3 is determined as described in point 1.5 above. The results are shown in Table 8.

TABLE 8
Results rubbing fastness test

Substrate

| | S1 | S2 | S3 |
|---|---|---|---|
| Rating rubbing fastness | Pass | Pass | Pass |

Each coating layer produced from aqueous coating compositions AC1-1 to AC1-3 containing sustainable pigments (i.e. recycled carbon black or dried coffee grounds) on the expanded and fused TPU bead substrate shows a sufficient rubbing fastness, i.e. is not damaged by rubbing on the coating layer with sandpaper. Upon rubbing with sandpaper, the color of the coating layer on substrates S1 and S2 (coating layer containing recycled carbon black) got darker while no color change was observed in case of coated substrate S3. Thus, the inventive aqueous coating compositions result in colored coating layers having a high abrasion resistance and are thus especially suitable for substrates encountering abrasion during their use, such as footwear. Moreover, the observed color change upon mechanical influence on the coating layer containing recycled carbon black pigments allows to tune the color of the coating layer by using a defined mechanical influence.

### 5.6 Hiding Power

The hiding power of the coating layer present on substrates S1 to S3 is determined as described in point 1.6 above. The results are shown in Table 9.

TABLE 9
Results hiding power

Substrate

| | S1 | S2 | S3 |
|---|---|---|---|
| Rating hiding power | Pass | Pass | Pass |

Each coating layer produced from aqueous coating compositions AC1-1 to AC1-3 containing sustainable pigments (i.e. recycled carbon black or dried coffee grounds) on the expanded and fused TPU bead substrate shows a high hiding power. It was observed that coated substrate S1 (containing recycled carbon black as pigment paste) has a darker color than coated substrate S2 (containing recycled carbon black pigment). The color of coated substrate S1 is comparable to the color achieved when using pigment pastes comprising virgin carbon black pigment. Thus, the use of recycled carbon black as pigment or pigment paste allows to tune the color of the resulting coating layer, rendering the aqueous coating compositions readily adaptable to the needs of the customer.

### 5.7 Uniformity of Color of Coating Layer

The uniformity of the color of the coating layer present on substrates S1 to S3 is determined as described in point 1.7 above. The results are shown in Table 10.

TABLE 10
Results uniformity of the color of the coating layer

Substrate

| | S1 | S2 | S3 |
|---|---|---|---|
| Rating color uniformity | Pass | Pass | Pass |

Each coating layer produced from aqueous coating compositions AC1-1 to AC1-3 containing sustainable pigments (i.e. recycled carbon black or dried coffee grounds) on the expanded and fused TPU bead substrate shows a high color uniformity, i.e. no color differences as well as no visual defects were observed. Thus, the inventive coating compositions allow to produce coating layers having a high optical quality when using sustainable pigments in the form of recycled carbon black or dried coffee grounds.

### 6. Discussion of the Results

The examples demonstrate that the coating composition results in colored coating layers having excellent visual properties, i.e. a sufficient hiding power and a good color uniformity, as well as excellent mechanical properties, i.e. a high weathering stability, abrasion resistance, flexibility and adhesion. Moreover, the use of sustainable pigments does not result in undesired migration of coloring material or other substances. The inventive coating materials containing sustainable recycled carbon black pigment or coffee grounds pigment thus allow to color substrates, especially flexible foam substrates used in the footwear industry, in an ecologically friendly way.

1. A coating composition comprising:
a) at least one binder,
b) at least one pigment selected from the group consisting of recycled carbon black, coffee grounds, and tea,
c) at least one solvent,
d) optionally at least crosslinking agent, and
e) optionally at least one additive.

2. The coating composition according to claim 1, wherein the at least one binder is selected from the group consisting of (i) poly(meth)acrylates, hydroxy-functional and/or carboxylate-functional and/or amine-functional poly(meth)acrylates, (ii) polyurethanes, hydroxy-functional and/or carboxylate-functional and/or amine-functional polyurethanes, (iii) polyesters, polyester polyols, (iv) polyethers, polyether polyols, (v) copolymers in the stated polymers, and (vi) mixtures thereof.

3. The coating composition according to claim 1, wherein the at least one binder is present in a total amount of 5 to 50 wt. % solids based on the total weight of the coating composition.

4. The coating composition according to claim 1, wherein the recycled carbon black pigment has a D₅₀ particle size of 1 to 150 μm.

5. The coating composition according to claim 1, wherein the recycled carbon black pigment is present in a total amount of 0.1 to 10 wt. % based on the total weight of the coating composition.

6. The coating composition according to claim 1, wherein the coffee grounds pigment is a dried coffee grounds pigment or wherein the tea pigment is a dried tea pigment.

7. The coating composition according to claim 6, wherein the dried coffee grounds pigment or the dried tea pigment is obtained by drying coffee grounds or tea at a temperature of 40 to 180° C. for a duration of 1 to 3 hours and grinding the dried coffee grounds or the dried tea.

8. The coating composition according to claim 6, wherein the dried coffee grounds or the dried tea has a D₅₀ particle size of 50 to 450 μm.

9. The coating composition according to claim 1, wherein the coffee grounds or tea pigment is each present in a total amount of 0.1 to 25 wt. % based on the total weight of the coating composition.

10. The coating composition according to claim 1, wherein the coating composition comprises—apart from the recycled carbon black pigment or coffee grounds pigment or tea pigment—0 wt. %, based on the total weight of the coating composition, of further pigments and/or fillers and/or dyes.

11. A method for producing a coating composition, said method comprising
(i) providing at least one pigment selected from the group consisting of recycled carbon black and coffee grounds or providing a pigment paste comprising recycled carbon black pigment and
(ii) adding the pigment or pigment paste provided in step (i) to at least one binder and at least one solvent and optionally at least one crosslinking agent and/or at least one additive.

12. A method for producing a coating (B) on a substrate (S), comprising a step of producing a colored coating (BC) directly on the substrate (S) by applying a coating composition (C1) according to claim 1 directly to the substrate (S), optionally drying the applied coating composition (C1) to form a coating film and curing the applied coating composition (C1) or the formed coating film.

13. A method for producing a coating (B) on a substrate (S), comprising
a step of producing a colored coating (BC) directly on the substrate (S) by applying a coating composition (C1) according to claim 1 to at least one inner surface of a mold and optionally drying the applied coating composition (C1),
applying a composition forming the substrate (S) into the mold,
forming the substrate (S) while simultaneously curing the coating composition (C1), and
removing the coated substrate from the mold.

14. A coating produced by the method according to claim 12.

15. A substrate bearing a coating according to claim 14.

16. A method for producing a coating (B) on a substrate (S), comprising a step of producing a colored coating (BC) directly on the substrate (S) by applying a coating composition (C1) prepared according to the method of claim 11 directly to the substrate (S), optionally drying the applied coating composition (C1) to form a coating film and curing the applied coating composition (C1) or the formed coating film.

17. A method for producing a coating (B) on a substrate (S), comprising
a step of producing a colored coating (BC) directly on the substrate (S) by applying a coating composition (C1) prepared according to the method of claim 11 to at least one inner surface of a mold and optionally drying the applied coating composition (C1),
applying a composition forming the substrate (S) into the mold,
forming the substrate (S) while simultaneously curing the coating composition (C1), and
removing the coated substrate from the mold.

18. A coating produced by the method according to claim 13.

19. A coating produced by the method according to claim 16.

20. A coating produced by the method according to claim 17.
